(19) United States
(12) Patent Application Publication
(10) Pub. No.: US 2008/0249865 A1
(43) Pub. Date: Oct. 9, 2008

(54) RECIPE AND PROJECT BASED MARKETING AND GUIDED SELLING IN A RETAIL STORE ENVIRONMENT

(76) Inventors: Robert Lee Angell, Salt Lake City, UT (US); James R. Kraemer, Santa Fe, NM (US)

Correspondence Address: DUKE W. YEE, YEE AND ASSOCIATES, P.C., P.O. BOX 802333, DALLAS, TX, 75380, US

(21) Appl. No.: 11/861,528

(22) Filed: Sep. 26, 2007

Related U.S. Application Data
(63) Continuation-in-part of application No. 11/695,983, filed on Apr. 3, 2007.

(51) Int. Cl. G06Q 30/00

(52) U.S. Cl. 705/14

(57) ABSTRACT

A computer implemented method, apparatus, and computer program product for generating project based marketing messages to a customer in a retail facility. In one embodiment, at least one item selected by the customer for purchase is identified. A task that requires the at least one item for completion of the task is identified. A set of additional items recommended for completion of the task is retrieved. The customer has not selected the items in the set of additional items for purchase. A customized marketing message for at least one item in the set of additional items recommended for completion of the task is generated. The customized marketing message is generated in real-time as the customer is shopping.

### CROSS-REFERENCE TO RELATED APPLICATIONS

This application is a continuation-in-part of patent application U.S. Ser. No. 11/695,983, filed Apr. 3, 2007, titled “Method and Apparatus for Providing Customized Digital Media Marketing Content Directly to a Customer”, which is incorporated herein by reference.

The present invention is also related to the following applications entitled Identifying Significant Groupings of Customers for Use in Customizing Digital Media Marketing Content Provided Directly to a Customer, application Ser. No. 11/744,024, filed May 3, 2007; Generating Customized Marketing Messages at a Customer Level Using Current Events Data, application Ser. No. 11/769,409, file Jun. 24, 2007; Generating Customized Marketing Messages Using Automatically Generated Customer Identification Data, application Ser. No. 11/756,198, filed May 31, 2007; Generating Customized Marketing Messages for a Customer Using Dynamic Customer Behavior Data, application Ser. No. 11/771,252, filed Jun. 29, 2007, Retail Store Method and System, Robyn Schwartz, Publication No. US 2006/0032915 A1 (filed Aug. 12, 2004); Business Offering Content Delivery, Robyn R. Levine, Publication No. US 2002/0111852 (filed Jan. 16, 2001) all assigned to a common assignee, and all of which are incorporated herein by reference.

### BACKGROUND OF THE INVENTION

1. Field of the Invention

The present invention is related generally to an improved data processing system, and in particular to a method and apparatus for processing digital video data. More particularly, the present invention is directed to a computer implemented method, apparatus, and computer usable program code for marketing products to consumers using recipe or project based marketing messages.

2. Description of the Related Art

In some cases, a customer shopping in a retail facility will only purchase a single, stand-alone item, such as a frozen “tv” dinner. However, a majority of the time, customers purchase multiple different complementary items that are required to complete a recipe or project. For example, if a customer purchases spaghetti pasta, the customer will frequently also purchase spaghetti sauce, garlic bread, mozzarella cheese, and/or other items that might be desired to prepare a complete spaghetti meal. Likewise, if a customer purchases paint, it is also probable that the customer will purchase paint brushes, paint rollers, painter's tape, and other items that are used to complete a painting project.

In the past, merchants, such as store owners and operators, frequently had a personal relationship with their customers. The merchant often knew their customers' names, address, marital status, ages of their children, hobbies, place of employment, anniversaries, birthdays, likes, dislikes and personal preferences. The merchant might be aware of projects that a particular customer is planning and/or the types of meals that the customer prefers to prepare. In addition, the customer might discuss their recipes or projects with the merchant to obtain advice as to which ingredients or items to purchase, where the ingredients or items are located in the store, and other helpful information.

However, with the continued growth of large cities, the corresponding disappearance of small, rural towns, and the increasing number of large, impersonal chain stores with multiple employees, the merchants and employees of retail businesses rarely recognize regular customers, and almost never know the customer's name or any other details regarding their customer's personal preferences, projects, or plans that might assist the merchant or employee in marketing efforts directed toward a particular customer. In addition, the anonymity of big box stores tends to deter customers from seeking advice or assistance from merchants at these large stores. In addition, it can be expensive for merchants to hire a sufficient number of employees to assist customers, give directions, and offer advice as to what items may be needed and where the items can be found in the store as the customers are shopping.

Currently, computers can be used to generate static marketing messages for customers based on user profile data, such as demographic data, point of contact data, and past transaction data. However, these marketing messages are generally mailed or emailed to customers at their home. However, current solutions do not utilize all of the potential dynamic customer data elements that may be available to a retail owner or operator for generating customized marketing messages targeted to individual customers. For example, the marketing offers do not reflect the ingredients or items needed by a customer to complete current projects or recipes that a customer is interested in preparing or completing. Other data pieces are needed to provide effective dynamic 1:1 marketing and guided selling to the potential customer. Therefore, the data elements in prior art only provide approximately seventy-five percent (75%) of the needed data.

### SUMMARY OF THE INVENTION

The illustrative embodiments provide a computer implemented method, apparatus, and computer program product for generating project based marketing messages to a customer in a retail facility. In one embodiment, at least one item selected by the customer for purchase is identified. A task that requires the at least one item for completion of the task is identified. A set of additional items recommended for completion of the task is retrieved. The customer has not selected the items in the set of additional items for purchase. A customized marketing message for at least one item in the set of additional items recommended for completion of the task is generated. The customized marketing message is generated in real-time as the customer is shopping.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which illustrative embodiments may be implemented;

FIG. 2 is a block diagram of a digital customer marketing environment in which illustrative embodiments may be implemented;

FIG. 3 is a block diagram of a data processing system in which illustrative embodiments may be implemented;

FIG. 4 is a block diagram of a data processing system for generating project based customized marketing messages in a digital customer marketing environment in accordance with an illustrative embodiment;

FIG. 5 is a block diagram of a shelf in a retail facility in accordance with an illustrative embodiment;

FIG. 6 is a block diagram of a shopping basket in accordance with an illustrative embodiment;

FIG. 7 is a block diagram of a dynamic marketing message assembly transmitting a project based customized marketing message to a set of display devices in accordance with an illustrative embodiment;

FIG. 8 is a block diagram of an identification tag reader for identifying items selected by a customer in accordance with an illustrative embodiment;

FIG. 9 is a block diagram illustrating an external marketing manager for generating current events data in accordance with an illustrative embodiment;

FIG. 10 is a block diagram illustrating a smart detection engine for generating customer identification data and selected item data in accordance with an illustrative embodiment;

FIG. 11 is a block diagram illustrating a list of recommended items for completing projects or recipes in accordance with an illustrative embodiment;

FIG. 12 is a flowchart illustrating a process for identifying a customer using dynamic data for the customer in accordance with an illustrative embodiment;

FIG. 13 is a flowchart illustrating a process for identifying a customer based on an identification of the customer's vehicle in accordance with an illustrative embodiment;

FIG. 14 is a flowchart illustrating a process for identifying project based recommended items in accordance with an illustrative embodiment;

FIG. 15 is a flowchart illustrating a process for identifying items selected by a customer in accordance with an illustrative embodiment; and

FIG. 16 is a flowchart illustrating a process for generating a project based customized marketing message using dynamic data in accordance with an illustrative embodiment.

### DETAILED DESCRIPTION OF THE PREFERRED EMBODIMENT

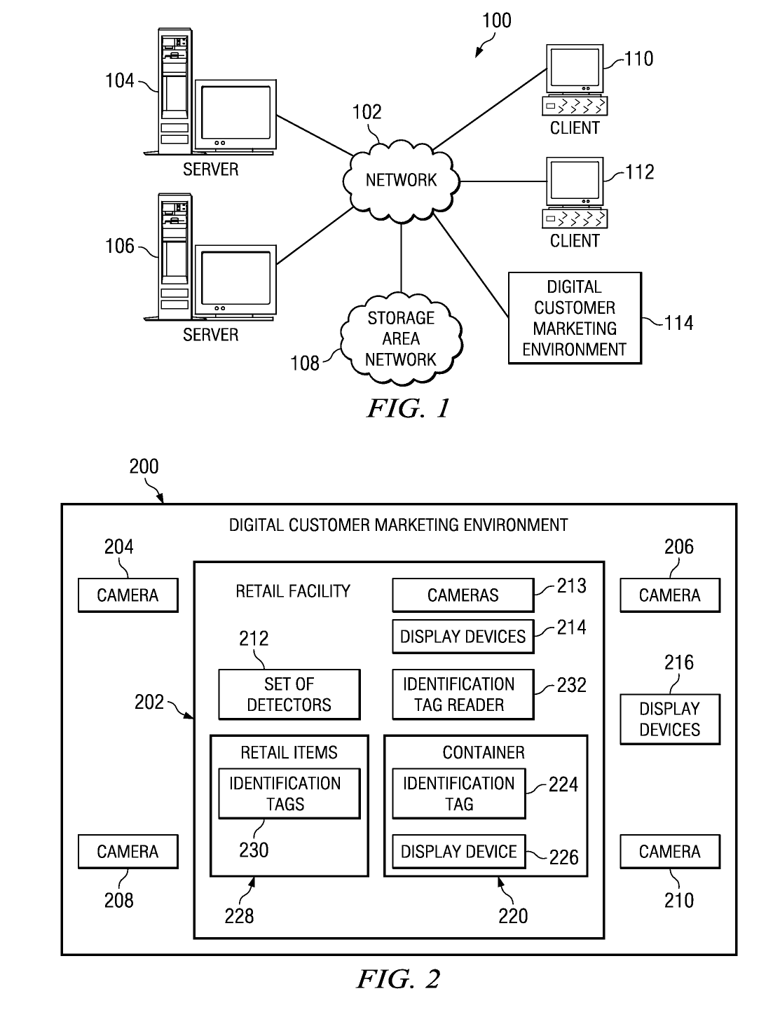

With reference now to the figures and in particular with reference to FIGS. 1-5, exemplary diagrams of data processing environments are provided in which illustrative embodiments may be implemented. It should be appreciated that FIGS. 1-5 are only exemplary and are not intended to assert or imply any limitation with regard to the environments in which different embodiments may be implemented. Many modifications to the depicted environments may be made.

With reference now to the figures, FIG. 1 depicts a pictorial representation of a network of data processing systems in which illustrative embodiments may be implemented. Network data processing system 100 is a network of computers in which embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage area network (SAN) 108. Storage area network 108 is a network connecting one or more data storage devices to one or more servers, such as servers 104 and 106. A data storage device, may include, but is not limited to, tape libraries, disk array controllers, tape drives, flash memory, a hard disk, and/or any other type of storage device for storing data. Storage area network 108 allows a computing device, such as client 110 to connect to a remote data storage device over a network for block level input/output.

In addition, clients 110 and 112 connect to network 102. These clients 110 and 112 may be, for example, personal computers or network computers. In the depicted example, server 104 provides data, such as boot files, operating system images, and applications to clients 110 and 112. Clients 110 and 112 are clients to server 104 in this example.

Digital customer marketing environment 114 is a retail environment that is connected to network 102. A customer may view, select order, and/or purchase one or more items in digital customer marketing environment 114. Digital customer marketing environment 114 may include one or more facilities, buildings, or other structures for wholly or partially containing the items.

Items in digital customer marketing environment 114 may include, but are not limited to, comestibles, clothing, shoes, toys, cleaning products, household items, machines, any type of manufactured items, entertainment and/or educational materials, as well as entrance or admittance to attend or receive an entertainment or educational activity, event, or service. Items for purchase could also include services, such as ordering dry cleaning services, food delivery, or any other services.

Comestibles include solid, liquid, and/or semi-solid food and beverage items. Comestibles may be, but are not limited to, meat products, dairy products, fruits, vegetables, bread, pasta, pre-prepared or ready-to-eat items, as well as unprepared or uncooked food and/or beverage items. For example, a comestible includes, without limitation, a box of cereal, a steak, tea bags, a cup of tea that is ready to drink, popcorn, pizza, candy, or any other edible food or beverage items.

An entertainment or educational activity, event, or service may include, but is not limited to, a sporting event, a music concert, a seminar, a convention, a movie, a ride, a game, a theatrical performance, and/or any other performance, show, or spectacle for entertainment or education of customers. For example, entertainment or educational activity or event could include, without limitation, the purchase of seating at a football game, purchase of a ride on a roller coaster, purchase of a manicure, or purchase of admission to view a film.

Digital customer marketing environment 114 may also includes a parking facility for parking cars, trucks, motorcycles, bicycles, or other vehicles for conveying customers to and from digital customer marketing environment 114. A parking facility may include an open air parking lot, an underground parking garage, an above ground parking garage, an automated parking garage, and/or any other area designated for parking customer vehicles.

For example, digital customer marketing environment 114 may be, but is not limited to, a grocery store, a retail store, a department store, an indoor mall, an outdoor mall, a combination of indoor and outdoor retail areas, a farmer's market, a convention center, a sports arena or stadium, an airport, a bus depot, a train station, a marina, a hotel, fair grounds, an amusement park, a water park, and/or a zoo.

Digital customer marketing environment 114 encompasses a range or area in which marketing messages may be transmitted to a digital display device for presentation to a customer within digital customer marketing environment. Digital multimedia management software is used to manage and/or enable generation, management, transmission, and/or display of marketing messages within digital customer marketing environment. Examples of digital multimedia management software include, but are not limited to, Scala® digital media/digital signage software, EK3® digital media/digital signage software, and/or Allure digital media software.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as, without limitation, an intranet, an Ethernet, a local area network (LAN), and/or a wide area network (WAN).

Network data processing system 100 may also include additional data storage devices, such as, without limitation, a hard disk, a compact disk (CD), a compact disk rewritable (CD-RW), a flash memory, a compact disk read-only memory (CD ROM), a non-volatile random access memory (NV-RAM), and/or any other type of storage device for storing data

FIG. 1 is intended as an example, and not as an architectural limitation for different embodiments. Network data processing system 100 may include additional servers, clients, data storage devices, and/or other devices not shown. For example, server 104 may also include devices not depicted in FIG. 1, such as, without limitation, a local data storage device. A local data storage device could include a hard disk, a flash memory, a non-volatile random access memory (NVRAM), a read only memory (ROM), and/or any other type of device for storing data.

In another embodiment, digital customer marketing environment 114 includes one or more servers located on-site at digital customer marketing environment. In this example, network 102 is optional. In other words, if one or more servers and/or data processing systems are located at digital customer marketing environment 114, the illustrative embodiments are capable of being implemented without a network connection.

A merchant, owner, operator, manager or other employee associated with digital customer marketing environment 114 typically wants to market products or services to a customer or potential customer in the most convenient and efficient manner possible so as to maximize resulting purchases by the customer and increase revenue. Therefore, the aspects of the illustrative embodiments recognize that it is advantageous for the merchant to have as much information as possible describing the customer and to anticipate items that the customer may wish to purchase prior to the customer selecting those items for purchase. to identify the best items to market to the customer and personalize the merchant's marketing strategy to that particular customer.

Therefore, the illustrative embodiments provide a computer implemented method, apparatus, and computer program product for generating project based marketing messages to a customer in a retail facility. In one embodiment, at least one item selected by the customer for purchase is identified. A customer selects an item for purchase by reaching for the item, picking up the item, holding the item, carrying the item, and/or placing the item in a shopping container, such as a cart, bag, or shopping basket.

A task that requires the at least one item for completion of the task is identified. As used herein, a task is a recipe or project that requires two or more items to complete the recipe or project. A set of additional items recommended for completion of the task is retrieved. The customer has not selected the items in the set of additional items for purchase. The term “set” refers to one or more. Thus, a set of additional items is a set of one or more additional items.

A customized marketing message for at least one item in the set of additional items recommended for completion of the task is generated. The customized marketing message is generated in real-time as the customer is shopping. The project based customized marketing message may be displayed to a customer at any time, either before the customer enters the retail facility, while the customer is actively shopping, during check-out, or after the customer leaves retail facility.

The customized marketing message includes information describing the location of one or more of the additional items, a recipe or instructions for completing the task, a list of items recommended for completion of the task that the customer has already selected for purchase, and/or a list of the items in the set of additional items recommended for completion of the task that the customer has not yet selected for purchase. For example, if the customer has purchased pizza crust and a pizza pan, the customized marketing message may include a recipe for making pizza, a list of additional ingredients needed for the recipe, such as tomato paste and mozzarella cheese. The project based marketing message may also include the location of the tomato paste and/or a location of the mozzarella cheese in the retail facility to make it easier for the customer to find these additional items. The marketing message may also include an incentive to purchase a particular brand or a particular package size of one or more of the additional items. An incentive is a discount, a rebate, a coupon, a sale price, an offer of a free gift, a reward, and/or a special offer provided to the customer to induce the customer to purchase one or more items.

In one embodiment, the process analyzes the items purchased by the customer in past transactions to identify recipes or projects that the customer has used in the past. The process compares the previous items purchased to ingredients recommended for completion of recipes. The process identifies recipes associated with ingredients that match the previous items purchased.

In other words, the process uses the shopping basket contents of the customer over repeated visits to the store to identify recipes used by the customer. The process offers recipes to the shopper prior to the customer beginning to shop and/or when the customer has just begun to shop but before the customer has completed shopping. Once the recipes are selected, the shopper is guided through the store and prompted to purchase appropriate ingredients.

If the process is unable to identify a recipe or project, the process prompts the customer to identify the recipe or project. A data processing system associated with the retail facility sends the prompt to a display device associated with the customer. In response to the customer identifying the task, the process displays the set of additional items recommended for completion of the task on the display device.

In one embodiment, when the customer selects a first item in the set of additional items, the process generates a next customized marketing message for a second item in the set of additional items. The next customized marketing message includes a location in the retail facility where the second item in the set of additional items is located and/or an incentive for the customer to purchase the second item. This process continues until the customer has selected all of the items in the recipe or project for purchase.

FIG. 2 is a block diagram of a digital customer marketing environment in which illustrative embodiments may be implemented. Digital customer marketing environment 200 is a marketing environment, such as digital customer marketing environment 114 in FIG. 1. Retail facility 202 is a facility for wholly or partially storing, enclosing, or displaying items for marketing, viewing, selection, order, and/or purchase by a customer. For example, retail facility 202 may be, without limitation, a retail store, supermarket, grocery store, a marketplace, a food pavilion, a book store, clothing store, department store, or shopping mall. Retail facility 202 may also include, without limitation, a sports arena, amusement park, water park, convention center, trade center, or any other facility for housing, storing, displaying, offering, providing, and/or selling items. In this example, retail facility 202 is a grocery store or a department store.

Cameras 204-210 are devices for gathering data associated with one or more customers or customer vehicles. A vehicle may include, but is not limited to, a car, bus, truck, motorcycle, boat, airplane, or any other type of vehicle.

In this example, cameras 204-210 are located at locations along an outer perimeter of digital customer marketing environment 200. However, cameras 204-210 may be located at any position within digital customer marketing environment 200 that is outside retail facility 202 to capture images of customers and customer vehicles before the customers enter retail facility 202 and/or after customers leave retail facility 202.

A camera may be any type of known or available camera, including, but not limited to, a video camera for taking moving video images, a digital camera capable of taking still pictures and/or a continuous video stream, a stereo camera, a web camera, and/or any other imaging device capable of capturing a view of whatever appears within the camera's range for remote monitoring, viewing, or recording of a distant or obscured person, object, or area.

Various lenses, filters, and other optical devices such as zoom lenses, wide angle lenses, mirrors, prisms and the like may also be used with an image capture device to assist in capturing the desired view. The image capture device may be fixed in a particular orientation and configuration, or it may, along with any optical devices, be programmable in orientation, light sensitivity level, focus or other parameters. Programming data may be provided via a computing device, such as server 104 in FIG. 1.

A camera may also be a stationary camera and/or non-stationary camera. A non-stationary camera is a camera that is capable of moving and/or rotating along one or more directions, such as up, down, left, right, and/or rotate about an axis of rotation. The camera may also be capable of moving to follow or track a person, animal, or object in motion. In other words, the camera may be capable of moving about an axis of rotation in order to keep a customer, animal, vehicle or object within a viewing range of the camera lens. In this example, cameras 204-210 are non-stationary digital video cameras.

Digital customer marketing environment 200 may also include one or more other detection devices (not shown) located outside retail facility. A detection device is a device for gathering data associated with a customer or vehicle, such as, without limitation, a camera, an audio recorder, a sound detection device, microphone, seismograph, pressure sensors, a device for detecting odors, scents, and/or fragrances, a motion detector, a thermal sensor or other heat sensor device, and/or any other device for detecting a presence of a human, animal, and/or conveyance vehicle outside of the retail facility.

A heat sensor is any known or available device for detecting heat, such as, but not limited to, a thermal imaging device for generating images showing thermal heat patterns. A heat sensor can detect body heat generated by a human or animal and/or heat generated by a vehicle, such as an automobile or a motorcycle. A set of heat sensors may include one or more heat sensors.

A motion detector may include, but is not limited to, a motion detector device using a photo-sensor, radar or microwave radio detector, or ultrasonic sound waves. A motion detector using ultrasonic sound waves transmits or emits ultrasonic sound waves. The motion detector detects or measures the ultrasonic sound waves that are reflected back to the motion detector. If a human, animal, or other object moves within the range of the ultrasonic sound waves generated by the motion detector, the motion detector detects a change in the echo of sound waves reflected back. This change in the echo indicates the presence of a human, animal, or other object moving within the range of the motion detector.

In one example, a motion detector device using a radar or microwave radio detector may detect motion by sending out a burst of microwave radio energy and detecting the same microwave radio waves when the radio waves are deflected back to the motion detector. If a human, animal, vehicle, or other object moves into the range of the microwave radio energy field generated by the motion detector, the amount of energy reflected back to the motion detector is changed. The motion detector identifies this change in reflected energy as an indication of the presence of a human, animal, vehicle, or other object moving within the motion detectors range.

A motion detector device, using a photo-sensor, detects motion by sending a beam of light across a space into a photo-sensor. The photo-sensor detects when a human, animal, or object breaks or interrupts the beam of light as the human, animal, or object by moving in-between the source of the beam of light and the photo-sensor. These examples of motion detectors are presented for illustrative purposes only. A motion detector in accordance with the illustrative embodiments may include any type of known or available motion detector and is not limited to the motion detectors described herein.

A pressure sensor detector may be, for example, a device for detecting a change in weight or mass associated with the pressure sensor. For example, if one or more pressure sensors are imbedded in a sidewalk, Astroturf, or floor mat, the pressure sensor detects a change in weight or mass when a human customer or animal steps on the pressure sensor. The pressure sensor may also detect when a human customer or animal steps off of the pressure sensor. In another example, one or more pressure sensors are embedded in a parking lot, and the pressure sensors detect a weight and/or mass associated with a human, animal, or vehicle in contact with the pressure sensor. A vehicle may be in contact with one or more pressure sensors when the vehicle is driving over one or more pressure sensors and/or when a vehicle is parked on top of one or more pressure sensors.

Cameras 204-210 are connected to an analysis server on a data processing system, such as network data processing system 100 in FIG. 1. The analysis server is illustrated and described in greater detail in FIG. 6 below. The analysis server includes software for analyzing digital images and other data captured by cameras 204-210 to track and/or visually identify retail items, containers, vehicles, and/or customers.

In this example, four cameras are located outside retail facility 202. However, any number of cameras may be used outside retail facility 202. For example, a single camera, as well as two or more cameras may be used outside retail facility 202.

Retail facility 202 may also optionally include set of detectors 212 inside retail facility 202. Set of detectors 212 is a set of one or more detectors, such as, without limitation, audio recorder, a sound detection device, microphone, seismograph, pressure sensors, a device for detecting odors, scents, and/or fragrances, a motion detector, a thermal sensor or other heat sensor device for gathering data associated with a human customer or an animal inside retail facility 202. The data gathered by set of detectors 212 and cameras 213 is processed by a smart detection engine to form customer identification data, vehicle identification data, and data describing items selected by a customer for purchase.

Set of detectors 212 may be located at any location within retail facility 202 and may include multiple detectors located at differing locations within retail facility 202. For example, a detector may be located, without limitation, at an entrance to retail facility 202, on one or more shelves in retail facility 202, and/or on one or more doors or doorways in retail facility 202.

Cameras 213 is a set of one or more cameras inside retail facility 202 for capturing images of customers, animals, shopping containers, contents of shopping containers, and/or items selected by customers for purchase inside retail facility 202. More than one image capture device may be operated simultaneously without departing from the illustrative embodiments of the present invention. Set of detectors 212 and cameras 213 are coupled to and/or in communication with the analysis server.

Display devices 214 are multimedia devices for displaying project based marketing messages to customers. Display devices 214 may be any type of device for presenting a text, graphic, audio, video, and/or any combination of text, graphics, audio, and video message to a customer. Display devices 214 include one or more display devices located within retail facility 202 for use and/or viewing by one or more customers.

Display devices 216 are located outside retail facility 202. Display devices 216 outside retail facility 202 may be used in the absence of display devices 214 inside retail facility 202 or in addition to display devices 214 located inside retail facility 202. For example, display devices 216 include, without limitation, a kiosk or display screen located in a parking lot, queue line, and/or other area outside of retail facility 202.

Display device 226 is operatively connected to a data processing system, such as data processing system 100 in FIG. 1 via wired, wireless, infrared, radio, or other connection technologies known in the art for the purpose of transferring data to be displayed on display device 226. The data processing system includes the analysis server for analyzing dynamic data obtained from cameras 204-210, set of detectors 212, and cameras 213, as well as static customer profile data obtained from one or more databases.

Container 220 is a container for holding, carrying, transporting, or moving one or more items selected for purchase by a customer. Container 220 is, without limitation, a shopping cart, a shopping bag, a shopping basket, and/or any other type of container for holding items. In this example, only one container 220 is depicted inside retail facility 202. However, any number of shopping containers and types of shopping containers may be used inside and/or outside retail facility 202.

Container 220 optionally includes identification tag 224 for identifying container 220, locating container 220 within digital customer marketing environment 200, either inside or outside retail facility 202, and/or associating container 220 with a particular customer. For example, identification tag 224 may be, but not limited to, a radio frequency identification (RFID) tag, a universal product code (UPC) tag, a global positioning system (GPS) tag, and/or any other type of identification tag for identifying, locating, and/or tracking a container.

Identification tag reader 225 is a device for obtaining information describing items selected by customers for purchase from tags associated with the items. Identification tag reader 225 is a reader such as, without limitation, a radio frequency identification tag reader and/or a Universal Product Code scanner. Identification tag reader 225 is coupled to, mounted on, attached to, or imbedded within container 220. For example, if a customer places a book in container 220 for purchase, identification tag reader 225 receives information from a tag associated with the book as the book is placed in container 220. The information may include the title of the book, the price of the book, and/or other information describing the book.

Container 220 may also include display device 226 coupled to, mounted on, attached to, or imbedded within container 220. Display device 226 is a multimedia display device for displaying textual, graphical, video, and/or audio marketing messages to a customer. The images shown on display device 227 may be changed in real time in response to various events such as the time of day, the day of the week, a particular customer approaching the shelves or rack, or items already placed inside container 220 by the customer.

Retail items 228 are items of merchandise for sale. Retail items 228 may be displayed on a display shelf (not shown) located in retail facility 202. Other items of merchandise that may be for sale, such as, without limitation, food, beverages, shoes, clothing, household goods, decorative items, or sporting goods, may be hung from display racks, displayed in cabinets, on shelves, or in refrigeration/freezer units (not shown). Any other type of merchandise display arrangement known in the retail trade may also be used.

Retail items 228 may be viewed or identified by the data processing system using data captured by cameras 213. Items may also be identified using identification tags 230 attached to retail items 228. Identification tags 230 are tags associated with one or more retail items for identifying the item and/or location of the item. For example, identification tags 230 may be, without limitation, a bar code pattern, such as a universal product code (UPC) or European article number (EAN), a radio frequency identification (RFID) tag, or other optical identification tag, depending on the capabilities of cameras 213, identification tag reader 225 and 232, and associated data processing system to process the information and make an identification of retail items 228. In some embodiments, an optical identification may be attached to more than one side of a given item.

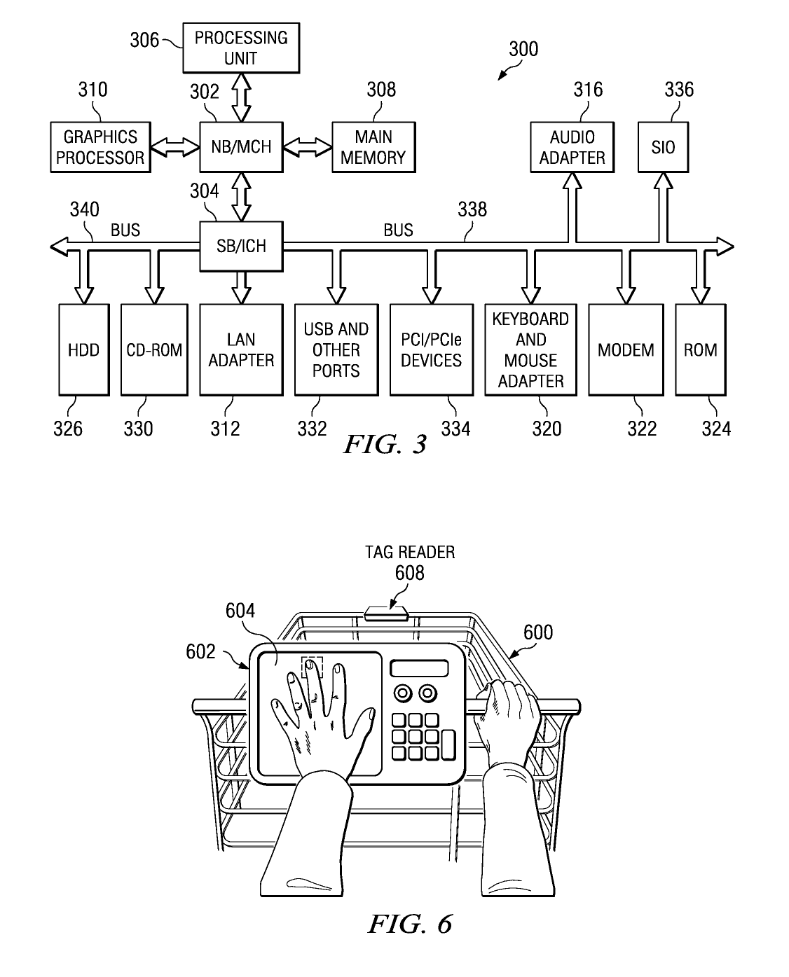

The data processing system, discussed in greater detail in FIG. 3 below, includes associated memory which may be an integral part, such as the operating memory, of the data processing system or externally accessible memory. Software for tracking objects may reside in the memory and run on the processor. The software is capable of tracking retail items 228 selected by a customer for purchase as the customer removes an item from its display position and places the item into container 220.

Likewise, the tracking software can track items which are being removed from container 220 and placed elsewhere in the retail store, whether placed back in their original display position or into another container. The tracking software can also track the position of container 220 and the customer.

The software can track retail items 228 by using data from one or more of cameras 204-210 located externally to retail facility 202, identification tag readers, cameras 213, and/or set of detectors 212. The software in the data processing system keeps a list of which items have been placed in each shopping container, such as container 220. The list is stored in a database. The database may be any type of database such as a spreadsheet, relational database, hierarchical database or the like. The database may be stored in the operating memory of the data processing system, externally on a secondary data storage device, locally on a recordable medium such as a hard drive, floppy drive, CD ROM, DVD device, remotely on a storage area network, such as storage area network 108 in FIG. 1, or in any other type of storage device.

The lists of items in container 220 are updated frequently enough to maintain a dynamic, accurate, real-time listing of the contents of each container as customers add and remove items from container 220. The listings of items in containers are also made available to whatever inventory system is used in retail facility 202. Such listings represent an up-to-the-minute view of which items are still available for sale, for example, to on-line shopping customers or customers physically located at retail facility 202. The listings may also provide a demand side trigger back to the supplier of each item. In other words, the listing of items in customer shopping containers can be used to update inventories, determine current stock available for sale to customers, and/or identification of items that need to be restocked or replenished.

At any time, the customer using container 220 may request to see a listing of the contents of container 220 by entering a query at a user interface to the data processing system. The user interface may be available at display devices 214, or display device 227 via a network connection. The customer may also make such a query after leaving the retail store, such as at display device 216 or at a computer at the customer's home. The listing of items selected for purchase is then displayed on the display device. The listing may include the quantity of each item in container 220, as well as the price for each, a discount or amount saved off the regular price of each item, a recipe or instructions for completing a project associated with one or more items selected for purchase, a list of additional items needed to complete the recipe or project, a location in retail facility 202 of the additional items needed to complete the recipe or project, and a total price for all items in container 220. Other data may also be displayed as part of the listing, such as, additional incentives to purchase one or more other items available in digital customer marketing environment 200.

When the customer is finished shopping, the customer may proceed to a point-of-sale checkout station. In one embodiment, the checkout station may be coupled to the data processing system. Therefore, the items in container 220 are already known to the data processing system due to the dynamic listing of items in container 220 that is maintained as the customer shops in digital customer marketing environment 200. Thus, there is no need for an employee, customer, or other person to scan each item in container 220 to complete the purchase of each item, as is commonly done today. In this example, the customer merely arranges for payment of the total, for example by use of a smart card, credit card, debit card, cash, or other payment method. In some embodiments, it may not be necessary to empty container 220 at the retail facility at all, for example, if container 220 is a minimal cost item which can be kept by the customer.

In other embodiments, container 220 may belong to the customer. In this example, the customer brings container 220 to retail facility 202 at the start of the shopping session. In another embodiment, container 220 belongs to retail facility 202 and must be returned before the customer leaves the parking lot or at some other designated time or place.

In another example, when the customer is finished shopping, the customer may complete checkout either in-aisle or from a final or terminal-based checkout position in the store using a transactional device which may be integral with container 220 or associated temporarily to container 220. The customer may also complete the transaction using a consumer owned computing device, such as a laptop, cellular telephone, or personal digital assistant that is connected to the data processing system via a network connection.

The customer may also make payment by swiping a magnetic strip on a card, using any known or available radio frequency identification (RFID) enabled payment device. The transactional device may also be a portable device such as a laptop computer, palm device, or any other portable device specially configured for such in-aisle checkout service, whether integral with container 220 or separately operable. In this example, the transactional device connects to the data processing system via a network connection to complete the purchase transaction at check out time.

Checkout may be performed in-aisle or at the end of the shopping trip whether from any point or from a specified point of transaction. As noted above, checkout transactional devices may be stationary shared devices or portable or mobile devices offered to the customer from the store or may be devices brought to the store by the customer, which are compatible with the data processing system and software residing on the data processing system.

Thus, in this depicted example, when a customer enters digital customer marketing environment 200 but before the customer enters retail facility 202, such as a retail store, the customer is detected by one or more cameras in cameras 204-210. The data processing system analyses the camera data to identify the customer and/or the customer's vehicle. If the customer takes a shopping container before entering retail facility 202, the shopping container is also identified. In some embodiments, the customer may be identified through identification of the container or identification of the customer's vehicle.

The customer is tracked using image data and/or other detection data captured by cameras 204-210 as the customer enters retail facility 202. The customer is identified and tracked inside retail facility 202 by one or more detectors inside the facility, such as set of detectors 212 and cameras 213. When the customer takes a shopping container, the analysis server uses data from identification tag readers 225 and/or 232 as well as data from set of detectors 212 and cameras 213, to track the customer, container 220, and/or items selected by the customer for purchase and placed in container 220.

As a result, an item selected by the customer, for example, as the customer removes the item from its stationary position on a store display, is identified. The selected item may be traced visually by a camera, tracked by another type of detector in set of detectors 212 and/or using identification data from identification tags 230. The item is tracked until the customer places it in container 220 to form a selected item.

Thus, a selected item is identified when a customer removes an item from a store display, such as a shelf, display counter, basket, or hanger. In another embodiment, the selected item is identified when the customer places the item in the customer's shopping basket, shopping bag, or shopping cart. The analysis server stores a listing of selected items placed in the shopping container. The analysis server also stores a listing of recipes and/or projects and the items that are recommended for completion of each recipe or project. The analysis server compares one or more items selected by the customer for purchase and/or past items purchased by the customer to identify a recipe or project. The analysis server then provides the recipe or project and additional items needed to complete the recipe or project to the customer.

In this example, a single container and a single customer is described. However, the aspects of the illustrative embodiments may also be used to track multiple containers and multiple customers simultaneously. In this case, the analysis server will store a separate listing of selected items for each active customer. As noted above, the listings may be stored in a database.

Thus, in one embodiment, a customer entering retail facility 202 is detected by one or more cameras in cameras 204-210. The camera images of the customer and/or the customer's vehicle are analyzed to identify the customer. An analysis server associated with retail facility 202 begins performing data mining on available static customer profile data elements, such as, demographic information and data describing items purchased in past transactions, for use in identifying recipes or projects and generating project based customized marketing messages targeted to the customer. Static customer data elements are data elements that do not tend to change in real time, such as a customer's name, date of birth, and address.

In one embodiment, the customer is presented with project based customized digital marketing messages on one or more display devices in display devices 216 located externally to retail facility 202 before the customer enters retail facility 202. When the customer enters retail facility 202, the customer is typically offered, provided, or permitted to take shopping container 220 for use during shopping. Container 220 may contain a digital media display, such as display device 226, mounted on container 220 and/or customer may be offered a handheld digital media display device, such as a display device in display devices 214. In the alternative, the customer may be encouraged to use strategically placed kiosks running digital media marketing messages throughout retail facility 202. Display device 226, 214, and/or 216 may include a verification device for verifying an identity of the customer, such as, without limitation, a fingerprint or thumbprint scanner, a voice analysis system, a user log-in and password, or a radio frequency identification tag reader 232 for reading a radio frequency identification tag, a smart card reader for reading a smart card, or a card reader for reading a specialized store loyalty or frequent customer card.

Once the customer has been verified, the data processing system retrieves past purchase history, total potential wallet-share, shopper segmentation information, customer profile data, granular demographic data for the customer, and/or any other available customer data elements using known or available data retrieval and/or data mining techniques. These customer data elements are analyzed using at least one data model to identify recipes and projects favored by the customer and/or determine appropriate digital media content to be pushed, on-demand, throughout the store to customers viewing display devices 214, 216, and/or display device 226.

Appropriate digital media content is content that the customer is likely to be receptive to, such as images, sounds, colors, themes, and products appropriate to the customer. For example, appropriate digital media content for an elderly customer that owns a cat could include denture cleaner and cat food while appropriate digital media content for a teenager that is allergic to cats may include acne medication, but not cat products.

The customer is provided with incentives to use display devices 214, 216, and/or display device 226 to obtain marketing incentives, promotional offers, and discounts for project based items. When the customer has finished shopping, the customer may be provided with a list of savings or “tiered” accounting of savings over the regular price of purchased items if a display device had not been used to view and use customized digital marketing messages. This process provides an intelligent guided selling methodology to optimize customer throughput in the store, thereby maximizing or optimizing total retail content and/or retail sales, profit, and/or revenue for retail facility 202.

It will be appreciated by one skilled in the art that the words “optimize”, “optimizating” and related terms are terms of art that refer to improvements in speed and/or efficiency of a computer implemented method or computer program, and do not purport to indicate that a computer implemented method or computer program has achieved, or is capable of achieving, an “optimal” or perfectly speedy/perfectly efficient state.

Next, FIG. 3 is a block diagram of a data processing system in which illustrative embodiments may be implemented. Data processing system 300 is an example of a computer, such as server 104 or client 110 in FIG. 1, in which computer usable code or instructions implementing the processes may be located for the illustrative embodiments. In this example, data is transmitted from data processing system 300 to the retail facility over a network, such as network 102 in FIG. 1. In another embodiment, data processing system 300 is located on-site at the retail facility.

In the depicted example, data processing system 300 employs a hub architecture including a north bridge and memory controller hub (MCH) 302 and a south bridge and input/output (I/O) controller hub (ICH) 304. Processing unit 306, main memory 308, and graphics processor 310 are coupled to north bridge and memory controller hub 302. Processing unit 306 may contain one or more processors and even may be implemented using one or more heterogeneous processor systems. Graphics processor 310 may be coupled to the MCH through an accelerated graphics port (AGP), for example.

In the depicted example, local area network (LAN) adapter 312 is coupled to south bridge and I/O controller hub 304 and audio adapter 316, keyboard and mouse adapter 320, modem 322, read only memory (ROM) 324, universal serial bus (USB) ports and other communications ports 332, and PCI/PCIe devices 334 are coupled to south bridge and I/O controller hub 304 through bus 338, and hard disk drive (HDD) 326 and CD-ROM drive 330 are coupled to south bridge and I/O controller hub 304 through bus 340. PCI/PCIe devices may include, for example, Ethernet adapters, add-in cards, and PC cards for notebook computers. PCI uses a card bus controller, while PCIe does not. ROM 324 may be, for example, a flash binary input/output system (BIOS). Hard disk drive 326 and CD-ROM drive 330 may use, for example, an integrated drive electronics (IDE) or serial advanced technology attachment (SATA) interface. A super I/O (SIO) device 336 may be coupled to south bridge and I/O controller hub 304.

An operating system runs on processing unit 306 and coordinates and provides control of various components within data processing system 300 in FIG. 3. The operating system may be a commercially available operating system such as Microsoft® Windows® XP (Microsoft and Windows are trademarks of Microsoft Corporation in the United States, other countries, or both). An object oriented programming system, such as the Java™ programming system, may run in conjunction with the operating system and provides calls to the operating system from Java programs or applications executing on data processing system 300. Java and all Java-based trademarks are trademarks of Sun Microsystems, Inc. in the United States, other countries, or both.

Instructions for the operating system, the object-oriented programming system, and applications or programs are located on storage devices, such as hard disk drive 326, and may be loaded into main memory 308 for execution by processing unit 306. The processes of the illustrative embodiments may be performed by processing unit 306 using computer implemented instructions, which may be located in a memory such as, for example, main memory 308, read only memory 324, or in one or more peripheral devices.

In some illustrative examples, data processing system 300 may be a personal digital assistant (PDA), which is generally configured with flash memory to provide non-volatile memory for storing operating system files and/or customer-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 308 or a cache such as found in north bridge and memory controller hub 302. A processing unit may include one or more processors or CPUs.

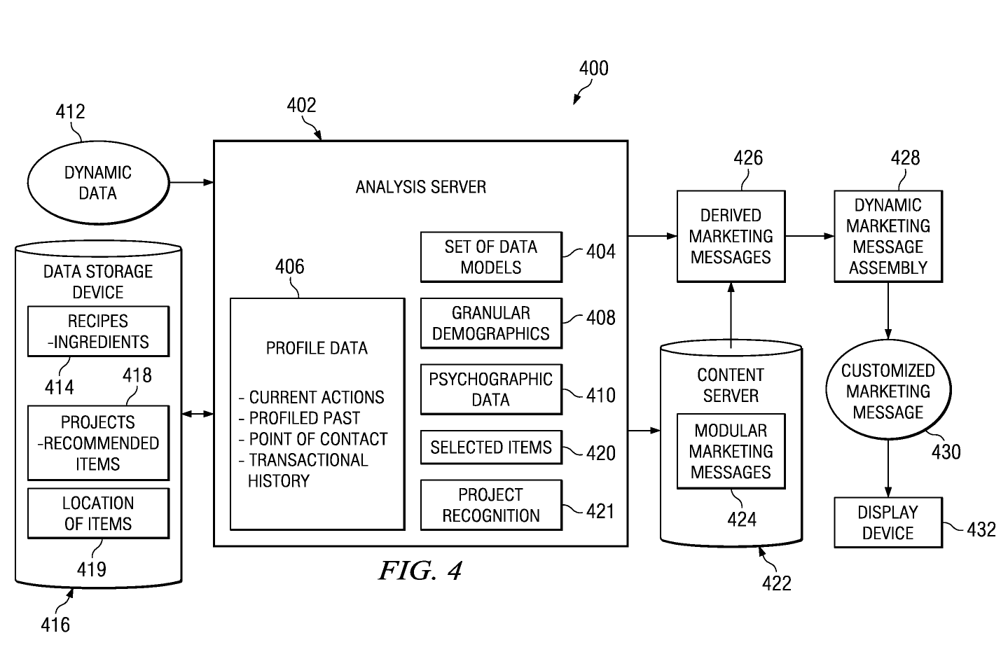

FIG. 4 is a block diagram of a data processing system for generating project based customized marketing messages in a digital customer marketing environment in accordance with an illustrative embodiment. Data processing system 400 is a data processing system, such as data processing system 100 in FIG. 1 and/or data processing system 300 in FIG. 3.

Analysis server 402 is any type of known or available server for analyzing dynamic customer data elements for use in generating project based customized marketing messages. Analysis server 402 may be implemented as server 104 in FIG. 1.

Analysis server 402 includes set of data models 404 for analyzing dynamic customer data elements and static customer data elements. Set of data models 404 is one or more data models created a priori or pre-generated for use in analyzing customer data objects and determining relationships between the customer data objects for use in personalizing marketing content presented to the customer. The data models are generated using at least one of a statistical method, a data mining method, a causal model, a mathematical model, a marketing model, a behavioral model, a psychological model, a sociological model, and/or a simulation model.

Profile data 406 is static customer data regarding one or more customers. Static customer data is data that is not currently or dynamically changing. In this example, profile data 406 includes point of contact data, profiled past data, current actions data, transactional history data, certain click-stream data, granular demographics 408, psychographic data 410, customer provided registration data, and/or account data. Profile data 604 for a given customer is stored in analysis server 402. However, profiled past data may also be stored in any local or remote data storage device. In addition, multiple storage devices and software may also be used to store profile data 406. Some or all of the data may be retrieved from the point of contact device, as well.

Point of contact data is data regarding a method or device used by a customer to interact with a data processing system associated with a retail facility and/or receive project based customized marketing message 430 for display. The customer may interact with the retail facilities data processing system using a computing device or display terminal having a user interface for inputting data and/or receiving output. The device or terminal may be a device provided by the retail facility and/or a device belonging to or provided by the customer. For example, the display or access device may include, but is not limited to, a cellular telephone, a laptop computer, a desktop computer, a computer terminal kiosk, personal digital assistant (PDA) or any other display or access device.

An indication of a location for the point of contact may also be determined. For example, global positioning system (GPS) coordinates of the customer may be determined if the customer device has such a capability whether by including a real time global positioning system receiver or by periodically storing global positioning system coordinates entered by some other method. Other location indications may also be determined such as, street or crossroad coordinates, latitude-longitude coordinates or any other location indicating system.

Analysis server 402 may also determine the connectivity associated with the customer's point of contact. For example, the customer may be connected to the retail facility's data processing system by means of, without limitation, a modem, digital modem, network, wireless network, Ethernet, intranet, or high speed line, including fiber optic lines. Each way of connection imposes constraints of speed, latency, and/or mobility.

The profiled past comprises data that may be used, in whole or in part, for personalization of customized marketing message 430. Global profile data may be retrieved from a file, database, data warehouse, or other data storage device. The profiled past may comprise an imposed profile, global profile, individual profile, and demographic profile. The profiles may be combined or layered to define the customer for specific promotions and marketing offers.

A global profile includes data on the customer's interests, preferences, and affiliations. The profiled past may also comprise retrieving purchased data, such as, without limitation, items purchased by the customer during past transactions. Various firms provide data for purchase which is grouped or keyed to presenting a lifestyle or life stage view of customers by block or group or some other baseline parameter. The purchased data presents a view of one or more customers based on aggregation of data points such as, but not limited to geographic block, age of head of household, income level, number of children, education level, ethnicity, and purchasing patterns.

The profiled past may also include navigational data relating to the path the customer used to arrive at a web page which indicates where the customer came from or the path the customer followed to link to the merchant or supplier's web page. Transactional data of actions taken is data regarding a transaction. For example, transaction data may include data regarding whether the transaction is a first time transaction or a repeat transaction, and/or how much the customer usually spends. Information on how much a customer generally spends during a given transaction may be referred to as basket share. Data voluntarily submitted by the customer in responding to questions or a survey may also be included in the profiled past.

Current actions, also called a current and historical record, are data defining customer behavior. One source of current actions is listings of the purchases made by the customer, payments and returns made by the customer, and/or click-stream data from a point of contact device of the customer. Click-stream data is data regarding a customer's navigation of an online web page of the merchant or supplier. Click-stream data may include page hits, sequence of hits, duration of page views, response to advertisements, transactions made, and conversion rates. Conversion rate is the number of times the customer takes action divided by the number of times an opportunity is presented.

Granular demographics 408 provides a detailed demographics profile for one or more customers. Granular demographics 408 may include, without limitation, age, ethnicity, block group, lifestyle, life stage, income, and education data. Granular demographics 408 may be used as an additional layer of profile data 406 associated with a customer.

Psychographic data 410 refers to an attitude profile of the customer. Examples of attitude profiles include, without limitation, a trend buyer, a time-strapped person who prefers quick purchases, such as to purchase a complete outfit, a cost-conscious shopper, a customer that prefers to buy in bulk, or a professional buyer who prefers to mix and match individual items from various suppliers.

Dynamic data 412 is data that includes dynamic customer data elements that are changing in real-time. For example, dynamic customer data elements could include, without limitation, the current contents of a customer's shopping basket, the time of day, the day of the week, whether it is the customer's birthday or other holiday observed by the customer, customer's responses to marketing messages and/or items viewed by the customer, customer location, the customer's current shopping companions, such as children or pets, the speed or pace at which the customer is walking through the retail facility, and/or any other dynamically changing customer information. Dynamic data 412 includes customer identification data, customer vehicle identification data, and/or current events data.

Dynamic data 412 is processed and/or analyzed to generate project based customized marketing messages and/or for utilization in selecting project based items to be marketed to the customer. Processing dynamic data 412 includes, but is not limited to, filtering dynamic data 412 for relevant data elements, combining dynamic data 412 with other dynamic and static customer data elements, comparing dynamic data 412 to baseline or comparison models for customer data, and/or formatting dynamic data 412 for utilization and/or analysis in one or more data models in set of data models 404. The processed dynamic data 412 is analyzed and/or further processed using one or more data models in set of data models 404.

Recipes 414 are a list of recipes that requires two or more ingredients for completion. Recipes 414 include the ingredients required to complete each recipe and the instructions for completing the recipe. Recipes 414 are stored in data storage device 416. Data storage device 416 is implemented as any type of data storage device, such as storage 108 in FIG. 1. Data storage device 416 may be located locally to analysis server 402 or remotely to analysis server 402. Data storage device 416 may be implemented as a single data storage device or as multiple data storage devices.

Projects 418 are a list of projects that requires two or more items to complete the project. Projects 418 include the items required to complete each project and instructions for completing the project.

Location of items 419 is a map or list identifying a location of each item offered for sale in retail facility. Location of items 419 is used to identify a location in retail facility of ingredients required by recipes 414 and/or a location of items required by projects 418. Selected item 420 is an identification of one or more items selected by a customer for purchase. An item is identified as selected item 420 when a customer looks at an item, reaches for an item, touches an item, picks up an item, places the item in a shopping container, such as container 220 in FIG. 2, places the item at a point of sale counter, purchases the item, indicates an interest in purchasing the item, makes a query regarding the item, requests information regarding the item, asks the merchant or sales person questions regarding the item, asks the merchant or sales person to see the item, or otherwise signals an intention to purchase the item.

The item is identified as a selected item using images of the customer received from a set of cameras, images of the item received from a set of cameras, data from a radio frequency identification tag associated with the item, data from a motion detector, data from a pressure sensor in contact with the item, and/or data from any other type of detection device capable of detecting changes associated with the position, placement, or movement of the item.

Project recognition 421 is software that performs a comparison between selected items and the items recommended for completion of projects and recipes. Project recognition 421 identifies a recipe or a project that requires one or more selected items for completion of the recipe or project. Analysis server 402 then generates a project based marketing message that includes one or more additional items required for completion of the recipe or project that the customer has not yet selected for purchase.

Recipes and projects may be identified using past purchasing histories for customers, sales records, customer profiles, customer behavior data, and current events for identifying seasonal and holiday related projects and recipes. Current events data indicates seasonal events or holidays, such as Christmas, Easter, Thanksgiving, the SuperBowl, Back-to-School in the fall, summer vacation from public school, New Year, and other seasonal events. A recipe or project can be identified by analysis server 402 based on current events, seasonal events, and holidays. For example, if current events data indicates that Thanksgiving is in two days and a customer selects a turkey for purchase, analysis server 402 identifies a recipe as a Thanksgiving dinner recipe. Analysis server 402 can then identify other recommended items needed to complete a Thanksgiving dinner, such as dressing, gravy, pumpkin pie, and so forth.

Content server 422 is any type of known or available server for storing modular marketing messages 424. Content server 422 may be a server, such as server 104 in FIG. 1 or data processing system 300 in FIG. 3.

Modular marketing messages 424 are two or more self contained marketing messages that may be combined with one or more other modular marketing messages in modular marketing messages 424 to form a customized marketing message for display to the customer. Modular marketing messages 424 can be quickly and dynamically assembled and disseminated to the customer in real-time.

In this illustrative example, modular marketing messages 424 are pre-generated. In other words, modular marketing messages 424 are preexisting marketing message units that are created prior to analyzing dynamic data 412 associated with a customer using one or more data models to generate a personalized marketing message for the customer. Two or more modular marketing messages are combined to dynamically generate customized marketing message 430 customized or personalized for a particular customer. Although modular marketing messages 424 are pre-generated, modular marketing messages 424 may also include templates imbedded within modular marketing messages for adding personalized information, such as a customer's name or address, to the customized marketing message.

Derived marketing messages 426 is a software component for determining which modular marketing messages in modular marketing messages 424 should be combined or utilized to dynamically generate customized marketing message 430 for the customer in real time. Derived marketing messages 426 uses the output generated by analysis server 402 as a result of analyzing dynamic data 412 associated with a customer using one or more appropriate data models in set of data models 404 to identify one or more modular marketing messages for the customer. The output generated by analysis server 402 from analyzing dynamic data 412 using appropriate data models in set of data models 404 includes marketing message criteria for the customer.

In other words, dynamic data 412 is analyzed to generate personal marketing message criteria. Derived marketing messages 426 uses the marketing message criteria for the customer to select one or more modular marketing messages in modular marketing messages 424.

A customized marketing message is generated using personalized marketing message criteria that are identified using the dynamic data. Personalized marketing message criteria are criterion or indicators for selecting one or more modular marketing messages for inclusion in the customized marketing message. The personalized marketing message criteria may include one or more criterion. The personalized marketing message criteria may be generated, in part, a priori or pre-generated and in part dynamically in real-time based on the dynamic data for the customer and/or any available static customer data associated with the customer. Dynamic data 412 includes external data gathered outside the retail facility and/or dynamic data gathered inside the retail facility.

If an analysis of dynamic data 412 indicates that the customer is shopping with a large dog, the personal marketing message criteria may include criteria to indicate marketing of pet food and items for large dogs. Because people with large dogs often have large yards, the personal marketing message criteria may also indicate that yard items, such as yard fertilizer, weed killer, or insect repellant may should be marketed. The personal marketing message criteria may also indicate marketing elements designed to appeal to animal lovers and pet owners, such as incorporating images of puppies, images of dogs, phrases such as “man's best friend”, “puppy love”, advice on pet care and dog health, and/or other pet friendly images, phrases, and elements to appeal to the customer's tastes and interests.

Derived marketing messages 426 uses the output of one or more data models in set of data models 404 that were used to analyze dynamic data 412 associated with a customer to identify one or more modular marketing messages to be combined together to form the personalized marketing message for the customer.

For example, if a customer selects peanut butter for purchase, analysis server 402 may identify a recipe for peanut butter and jelly sandwiches. In response, a first modular marketing message may be a special on a more expensive brand of peanut butter. A second modular marketing message may be a discount on jelly when peanut butter is purchased with the jelly. In response to marketing message criteria that indicates the customer frequently purchases cheaper brands of peanut butter, the customer has children, and the customer is currently in an aisle of the retail facility that includes jars of peanut butter, derived marketing messages 426 will select the first marketing message and the second marketing message based on the items recommended for completion of the peanut butter and jelly sandwiches recipe and the marketing message criteria for the customer.

Dynamic marketing message assembly 428 is a software component for combining the one or more modular marketing messages selected by derived marketing messages 426 to form customized marketing message 430. Dynamic marketing message assembly 428 combines modular marketing messages selected by derived marketing messages 426 to create appropriate customized marketing message 430 for the customer. In the example above, after derived marketing messages 426 selects the first modular marketing message and the second modular marketing message based on the marketing message criteria, dynamic marketing message assembly 428 combines the first and second modular marketing messages to generate a customized marketing message offering the customer a discount on both the peanut butter and jelly if the customer purchases the more expensive brand of peanut butter. In this manner, dynamic marketing message assembly 428 provides assembly of customized marketing message 430 based on output from the data models analyzing internal data and/or external data associated with the customer.

Customized marketing message 430 is a customized and unique marketing message for items needed to complete a recipe or project. The marketing message is a one-to-one customized marketing message for a specific customer. Customized marketing message 430 is generated using dynamic data 412 and/or static customer data elements, such as the customer's demographics and psychographics, to achieve this unique one-to-one marketing.

Customized marketing message 430 is generated for a particular customer based on dynamic customer data elements, such as grouping data, customer identification data, current events data, and customer behavior data. For example, if modular marketing messages 424 include marketing messages identified by numerals 1-20, customized marketing message 430 may be generated using marketing messages 2, 8, 9, and 19. In this example, modular marketing messages 2, 8, 9, and 19 are combined to create a customized marketing message that is generated for display to the customer rather than displaying the exact same marketing messages to all customers.

Customized marketing message 430 is displayed on display device 432. If display device 432 is a display device associated with the retail facility, details and information regarding display device 432 will be known to analysis server 402. However, if display device 432 is a display device belonging to the customer or brought to the retail facility by the customer, analysis server 402 may identify the type of display device using techniques such as interrogation commands, cookies, or any other known or equivalent technique. From the type of device other constraints may be determined such as display size, resolution, refresh rate, color capability, keyboard entry capability, other entry capability such as pointer or mouse, speech recognition and response, language constraints, and any other fingertip touch point constraints and assumptions about customer state of the display device. For example, someone using a cellular phone may have a limited time window for making phone calls and be sensitive to location and local time of day, whereas a casual home browser may have a greater luxury of time and faster connectivity.

Customized marketing message 430 may include advertisements, sales, special offers, incentives, opportunities, promotional offers, rebate information and/or rebate offers, discounts, and opportunities. An opportunity may be a “take action” opportunity, such as asking the customer to make an immediate purchase, select a particular item, request a download, provide information, or take any other type of action. Customized marketing message 430 may also include content or messages pushing advertisements and opportunities to effectively and appropriately drive the point of contact customer to some conclusion or reaction desired by the merchant.

Customized marketing message 430 is formed in a dynamic closed loop manner in which the content delivery depends on dynamic data 412, as well as other dynamic customer data elements and static customer data, such as profile data 406 and granular demographics 408. Therefore, all interchanges with the customer may sense and gather data associated with customer behavior, which is used to generate customized marketing message 430.

Display device 432 is a multimedia display for presenting customized marketing messages to one or more customers. Display device 432 may be a multimedia display, such as, but not limited to, display devices 214, 216, and 226 in FIG. 2. Thus, a merchant has a capability for interacting with the customer on a direct one-to-one level by sending customized marketing message 430 to display device 432. Customized marketing message 430 may be sent and displayed to the customer via a network. For example, customized marketing message 430 may be sent via a web site accessed as a unique uniform resource location (URL) address on the World Wide Web, as well as any other networked connectivity or conventional interaction including, but not limited to, a telephone, computer terminal, cell phone or print media.

In response to displaying customized marketing message 430, a customer can select to print the customized marketing message 430 as a coupon and/or as a paper or hard copy for later use. In another embodiment, display device 432 automatically prints customized marketing message 430 for the customer rather than displaying customized marketing message 430 on a display screen or in addition to displaying customized marketing message 430 on the display screen. Display device 432 may also provides an option for a customer to save customized marketing message 430 in an electronic form for later use. For example, the customer may save customized marketing message 430 on a hand held display device, on a flash memory, a customer account in a data base associated with analysis server 402, or any other data storage device. In this example, when customized marketing message 430 is displayed to the customer, the customer is presented with a “use offer now” option and a “save offer for later use” option. If the customer chooses the “save offer” option, the customer may save an electronic copy of customized marketing message 430 and/or print a paper copy of customized marketing message 430 for later use.

In this example, customized marketing message 430 is generated and delivered to the customer in response to the customer choosing selected item 420. Customized marketing message 430 prompts the customer to purchase at least one additional item needed for a recipe or project.

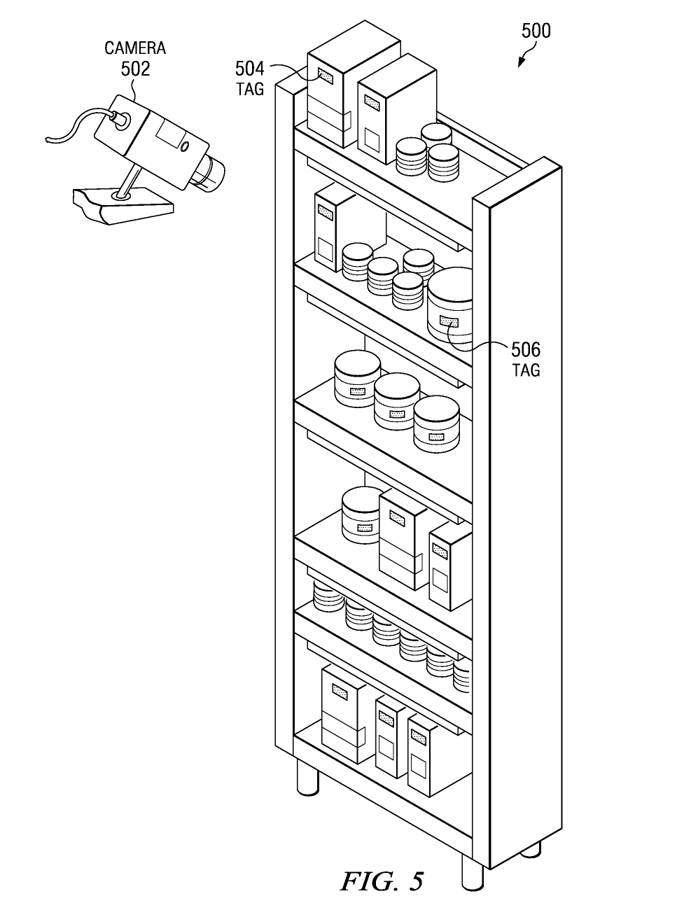

FIG. 5 is a block diagram of a shelf in a retail facility in accordance with an illustrative embodiment. Shelf 500 is any type of device for showing, displaying, storing, or holding items. Shelf 500 may be a shelf in a refrigerator or a freezer, as well as a shelf at room temperature.

Camera 502 is a camera located inside a retail facility for capturing images of customers and items selected by customers for purchase. Camera 502 may be implemented using any type of known or available camera. Camera 502 may optionally include microphones for capturing audio data associated with customers.

Shelf 500 includes a plurality of items offered for sale. The plurality of items includes identification tags, such as, without limitation, universal product codes and/or radio frequency identification tags. In this example, tag 504 and tag 506 are radio frequency identification tags. A radio frequency identification tag reader uses information received from tags 504 and 506 to determine when a customer selects an item associated with tags 504 and/or 506.

Turning now to FIG. 6, a block diagram of a shopping basket is shown in accordance with an illustrative embodiment. Shopping container 600 is a container for carrying, moving, or holding items selected by a customer, such as container 220 in FIG. 2. In this example, container 600 is a shopping cart.

Display device 602 is a multimedia display device for presenting or displaying customized digital marketing messages to one or more customers, such as display devices 226 in FIG. 2, and/or display device 432 in FIG. 4. In this example, display device is coupled to shopping container 600. Display device 602 displays recipe based customized digital marketing messages.

Fingerprint scanner 604 is any type of known or available device for identifying a customer using a customer's fingerprint or thumbprint. Once the customer is identified, a customer profile for the customer can be retrieved and utilized to identify recipes and projects for the customer, as well as customize marketing message content for the customer. In another embodiment, the customer is identified by prompting the customer to manually enter the customer's identity, analyzing the customer's voice, performing a retinal scan of the customer's retina, prompting the customer to swipe a customer rewards card or frequent shopper card, identifying the customer based on the customer's vehicle, and/or any other method of identifying a customer.

In one example, display device 602 may, but is not required to, connect to a remote data storage device storing data to retrieve customer fingerprint data for use in identifying a given customer using the customer's fingerprint. Display device 602 may be connected to the remote data storage device via a wireless network connection, such as network 102 in FIG. 1.

In this example, fingerprint scanner 604 is included within or coupled to display device 602. However, fingerprint scanner 604 may be coupled, attached, or imbedded in or on any part or member of shopping container 1100. Fingerprint scanner 604 may also be located separately from display device 602. For example and without limitation, fingerprint scanner 604 could be embedded in a door or located in an entry way to identify the customer when the customer enters the retail facility.

Tag reader 608 is a device for obtaining information associated with a given item from a tag attached to the item. Tag reader 608 is implemented in a device, such as, identification tag reader 225 or 232 in FIG. 2. In this example, tag reader 608 is a radio frequency identification tag reader. Tag reader 608 may be located on any part or member of shopping container 600.

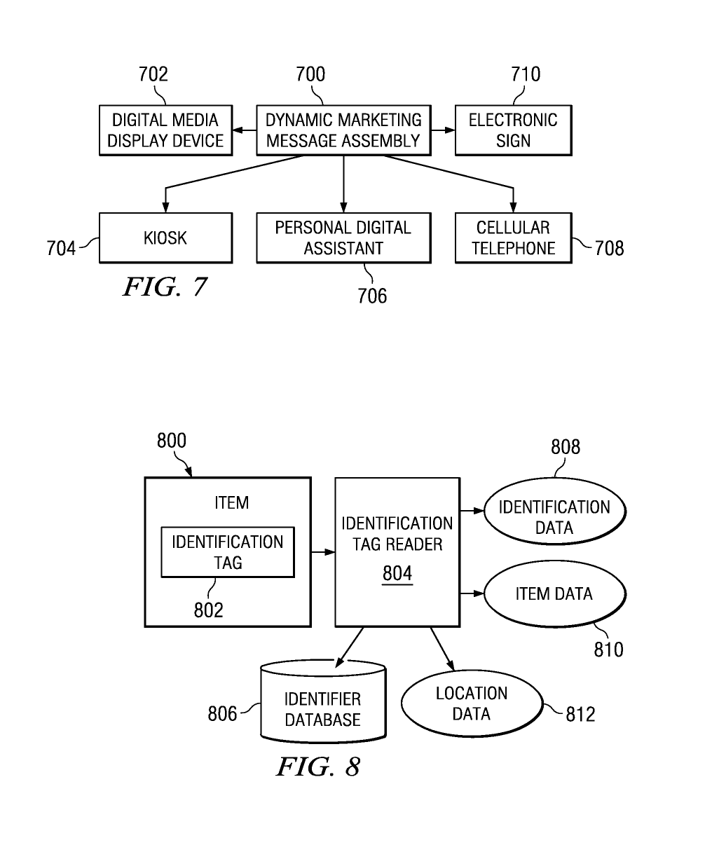

FIG. 7 is a block diagram of a dynamic marketing message assembly transmitting a project based customized marketing message to a set of display devices in accordance with an illustrative embodiment. Dynamic marketing message assembly 700 is a software component for combining two or more modular marketing messages into a customized marketing message for a customer. Dynamic marketing message assembly 700 may be a component such as dynamic marketing message assembly 628 in FIG. 6.

Dynamic marketing message assembly 700 transmits a customized marketing message, such as customized marketing message 430 in FIG. 4, to one or more display devices in a set of display devices. In this example, the set of display devices includes, but is not limited to, digital media display device 702, kiosk 704, personal digital assistant 706, cellular telephone 708, and/or electronic sign 710. A set of display devices in accordance with the illustrative embodiments may include any combination of display devices and any number of each type of display device. For example, a set of display devices may include, without limitation, six kiosks, fifty personal digital assistants, and no cellular telephones. In another example, the set of display devices may include electronic signs and kiosks but no personal digital assistants or cellular telephones.

Digital media display device 702 is any type of known or available digital media display device for displaying a marketing message. Digital media display device 702 may include, but is not limited to, a monitor, a plasma screen, a liquid crystal display screen, and/or any other type of digital media display device.

Kiosk 704 is any type of known or available kiosk. In one embodiment, a kiosk is a structure having one or more open sides, such as a booth. The kiosk includes a computing device associated with a display screen located inside or in association with the structure. The computing device may include a user interface for a user to provide input to the computing device and/or receive output. For example, the user interface may include, but is not limited to, a graphical user interface (GUI), a menu-driven interface, a command line interface, a touch screen, a voice recognition system, an alphanumeric keypad, and/or any other type of interface.

Personal digital assistant 706 is any type of known or available personal digital assistant (PDA). Cellular telephone 708 is any type of known or available cellular telephone and/or wireless mobile telephone. Cellular telephone 708 includes a display screen that is capable of displaying pictures, graphics, and/or text. Additionally, cellular telephone 708 may also include an alphanumeric keypad, joystick, and/or buttons for providing input to cellular telephone 708. The alphanumeric keypad, joystick, and/or buttons may be used to initiate various functions in cellular telephone 708. These functions include for example, activating a menu, displaying a calendar, receiving a call, initiating a call, displaying a customized marketing message, saving a customized marketing message, and/or selecting a saved customized marketing message.

Electronic sign 710 is any type of electronic messaging system. For example, electronic sign 710 may include, without limitation, an outdoor electronic light emitting diode (LED) display, moving message boards, variable message signs, tickers, electronic message centers, video boards, and/or any other type of electronic signage.

The display device may also include, without limitation, a laptop computer, a smart watch, a digital message board, a monitor, a tablet PC, a printer for printing the customized marketing message on a paper medium, or any other output device for presenting output to a customer.

A display device may be located externally to the retail facility to display marketing messages to the customer before the customer enters the retail facility. In another embodiment, the customized marketing message is displayed to the customer on a display device inside the retail facility after the customer enters the retail facility and begins shopping.

Turning now to FIG. 8, a block diagram of an identification tag reader for identifying items selected by a customer is shown in accordance with an illustrative embodiment. Item 800 is any type of item, such as retail items 228 in FIG. 2. Identification tag 802 associated with item 800 is a tag for providing information regarding item 800 to identification tag reader 804. Identification tag 802 is a tag such as a tag in identification tags 230 in FIG. 2. Identification tag 802 may be a bar code, a radio frequency identification tag, a global positioning system tag, and/or any other type of tag.

Radio Frequency Identification tags include read-only identification tags and read-write identification tags. A read-only identification tag is a tag that generates a signal in response to receiving an interrogate signal from an item identifier. A read-only identification tag does not have a memory. A read-write identification tag is a tag that responds to write signals by writing data to a memory within the identification tag. A read-write tag can respond to interrogate signals by sending a stream of data encoded on a radio frequency carrier. The stream of data can be large enough to carry multiple identification codes. In this example, identification tag 802 is a radio frequency identification tag.

Identification tag reader 804 is any type of known or available device for retrieving information from identification tag 802. Identification tag reader 804 may be, but is not limited to, a radio frequency identification tag reader or a bar code reader, such as identification tag reader 232 in FIG. 2. A bar code reader is a device for reading a bar code, such as a universal product code. In this example, identification tag reader 804 provides identification data 808, item data 810, and/or location data 812 to an analysis server, such as analysis server 402 in FIG. 4.

Identification data 808 is data regarding the product name and/or manufacturer name of item 800 selected for purchase by a customer. Item data 810 is information regarding item 800, such as, without limitation, the regular price, sale price, product weight, and/or tare weight for item 800. Identification data 808 is used to identify a selected item, such as selected item 420 in FIG. 4. Once the selected item has been identified, a recipe or project that uses the selected item is identified.

Location data 812 is data regarding a location of item 800 within the retail facility and/or outside the retail facility. For example, if identification tag 802 is a bar code, the item associated with identification tag 802 must be in close physical proximity to identification tag reader 804 for a bar code scanner to read a bar code on item 800. Therefore, location data 812 is data regarding the location of identification tag reader 804 currently reading identification tag 802. However, if identification tag 802 is a global positioning system tag, a substantially exact or precise location of item 800 may be obtained using global positioning system coordinates obtained from the global positioning system tag.

Identifier database 806 is a database for storing any information that may be needed by identification tag reader 804 to read identification tag 802. For example, if identification tag 802 is a radio frequency identification tag, identification tag will provide a machine readable identification code in response to a query from identification tag reader 804. In this case, identifier database 806 stores description pairs that associate the machine readable codes produced by identification tags with human readable descriptors. For example, a description pair for the machine readable identification code “10101010111111” associated with identification tag 802 would be paired with a human readable item description of item 800, such as “orange juice.” An item description is a human understandable description of an item. Human understandable descriptions are for example, text, audio, graphic, or other representations suited for display or audible output.

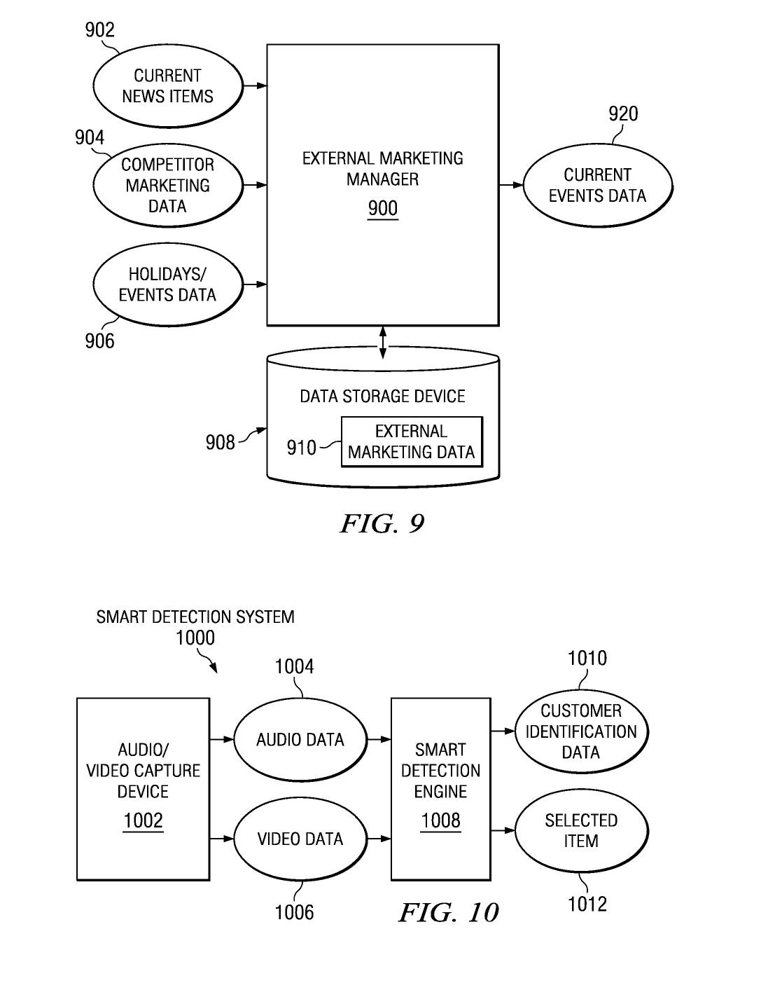

FIG. 9 is a block diagram illustrating an external marketing manager for generating current events data in accordance with an illustrative embodiment. External marketing manager 900 is a software component for collecting current news item 902, competitor marketing data 904, holidays, seasonal events, seasonal celebrations, and/or events data 906, and/or any other current events or news data from a set of sources. The set of sources may include one or more sources. A source may be, without limitation, a newspaper, catalog, a web page or other network resource, a television program or commercial, a flier, a pamphlet, a book, a booklet, a news board, a coupon board, a news group, a blog, a magazine, a religious calendar, a secular calendar, or any other paper or electronic source of information. A source may also include information provided by a human user.

External marketing manager 900 stores current news item 902, competitor marketing data 904, holidays and/or events data 906, and/or any other current events or news data in data storage device 908 as external marketing data 910. Data storage device 908 may be implemented as any type of data storage device, including, without limitation, a hard disk, a database, a main memory, a flash memory, a random access memory (RAM), a read only memory (ROM), or any other data storage device.

In this example, external marketing manager 900 filters or processes external marketing data 910 to form current events data 920. Filtering external marketing data 910 may include selecting data items or data objects associated with marketing one or more items to a customer. A data item or data object associated with marketing one or more items is a data element that may influence a customer's decision to purchase a product. For example, the occurrence of a sporting event may influence the projects and/or recipes used by a customer, such as recipes for pizza and projects such as installation of large screen televisions and high definition video players.

A data element indicating the occurrence of a holiday or religious event, such as Christmas or Thanksgiving, may also influence the recipes and projects undertaken by a customer. For example, as Thanksgiving approaches, customers are more likely to be planning recipes for Thanksgiving dinner, such as turkey and pumpkin pie. At Easter, customers are more likely to be using recipes for ham and making colored Easter eggs.

A data element indicating that a storm or hurricane is approaching may influence projects such as installing storm shutters and generators. These data elements that may influence customer purchases and sales of items are selected to form current events data 920. Current events data 920 is then sent to an analysis server, such as analysis server 602 in FIG. 6 for use in identifying recipes and projects, as well as personalizing marketing messages to a customer.

In this example, external marketing manager 900 filters external marketing data 910 for relevant data elements to form current events data 920 without intervention by a human user. In another embodiment, a human user filters external marketing data 910 manually to generate current events data 920. The analysis server uses the current events data to identify an event of interest to the customer that occurs within a predetermined period of time. For example, if a customer profile and dynamic data indicates that the customer is Catholic and current events data 920 indicates Mardi Gras is approaching, the analysis server can identify recipes and projects associated with Mardi Gras, such as King Cake and projects for Mardi Gras decorations that include items such as Mardi Gras beads and masks.

FIG. 10 is a block diagram illustrating a smart detection engine for generating customer identification data and selected item data in accordance with an illustrative embodiment. Smart detection system 1000 is a software architecture for analyzing camera images and other detection data to form dynamic data 1020. In this example, the detection data is video images captured by a camera. However, the detection data may also include, without limitation, pressure sensor data captured by a set of pressure sensors, heat sensor data captured by a set of heat sensors, motion sensor data captured by a set of motion sensors, audio captured by an audio detection device, such as a microphone, or any other type of detection data described herein.

Audio/video capture device 1002 is a device for capturing video images and/or capturing audio. Audio/video capture device 1002 may be, but is not limited to, a digital video camera, a microphone, a web camera, or any other device for capturing sound and/or video images.

Audio data 1004 is data associated with audio captured by audio/video capture device 1002, such as human voices, vehicle engine sounds, dog barking, horns, and any other sounds. Audio data 1004 may be a sound file, a media file, or any other form of audio data. Audio/video capture device 1002 captures audio associated with a set of one or more customers inside a retail facility and/or outside a retail facility to form audio data 1004.

Video data 1006 is image data captured by audio/video capture device 1002. Video data 1006 may be a moving video file, a media file, a still picture, a set of still pictures, or any other form of image data. Video data 1006 is video or images associated with a set of one or more customers inside a retail facility and/or outside a retail facility.

For example, video data 1006 may include images of a customer's face, an image of a part or portion of a customer's car, an image of a license plate on a customer's car, and/or one or more images showing a customer's behavior. An image showing a customer's behavior or appearance may show a customer wearing a long coat on a hot day, a customer walking with two small children which may be the customer's children or grandchildren, a customer moving in a hurried or leisurely manner, or any other type of behavior or appearance attributes of a customer, the customer's companions, or the customer's vehicle.

Audio/video capture device 1002 transmits audio data 1004 and video data 1006 to smart detection engine 1008. Audio data 1004 and video data 1006 may be referred to as detection data. Smart detection engine 1008 is software for analyzing audio data 1004 and video data 1006. In this example, smart detection engine 1008 processes audio data 1004 and video data 1006 into data and metadata to form dynamic data, including, but not limited to, customer identification data 1010. Processing the audio data 1004 and video data 1006 may include filtering audio data 1004 and video data 1006 for relevant data elements, analyzing audio data 1004 and video data 1006 to form metadata describing or categorizing the contents of audio data 1004 and video data 1006, or combining audio data 1004 and video data 1006 with other audio data, video data, and data associated with a group of customers received from cameras.

Smart detection engine 1008 uses computer vision and pattern recognition technologies to analyze audio data 1004 and/or video data 1006. Smart detection engine 1008 includes license plate recognition technology which may be deployed in a parking lot or at the entrance to a retail facility where the license plate recognition technology catalogs a license plate of each of the arriving and departing vehicles in a parking lot associated with the retail facility.

Smart detection engine 1008 includes behavior analysis technology to detect and track moving objects and classify the objects into a number of predefined categories. As used herein, an object may be a human customer, an item, a container, a shopping cart or shopping basket, or any other object inside or outside the retail facility. Behavior analysis technology could be deployed on various cameras overlooking a parking lot, a perimeter, or inside a facility.

Face detection/recognition technology may be deployed in parking lots, at entry ways, and/or throughout the retail facility to capture and recognize faces. Badge reader technology may be employed to read badges. Radar analytics technology may be employed to determine the presence of objects. Events from access control technologies can also be integrated into smart detection engine 1008.

The events from all the above detection technologies are cross indexed into a single repository, such as multi-mode database. In such a repository, a simple time range query across the modalities will extract license plate information, vehicle appearance information, badge information, and face appearance information, thus permitting an analyst to easily correlate these attributes.

Smart detection system 1000 may be implemented using any known or available software for performing voice analysis, facial recognition, license plate recognition, and sound analysis. In this example, smart detection system 1000 is implemented as IBM® smart surveillance system (S3) software.

The data gathered from the behavior analysis technology, license plate recognition technology, face detection/recognition technology, badge reader technology, radar analytics technology, and any other video/audio data received from a camera or other video/audio capture device is received by smart detection engine 1008 for processing into dynamic data, such as dynamic data 412 in FIG. 4. Dynamic data includes customer identification data 1010, vehicle identification data, customer grouping data, and data describing selected item 1012. Customer grouping data is data describing a customer's companions, such as children, parents, siblings, peers, friends, and/or pets.

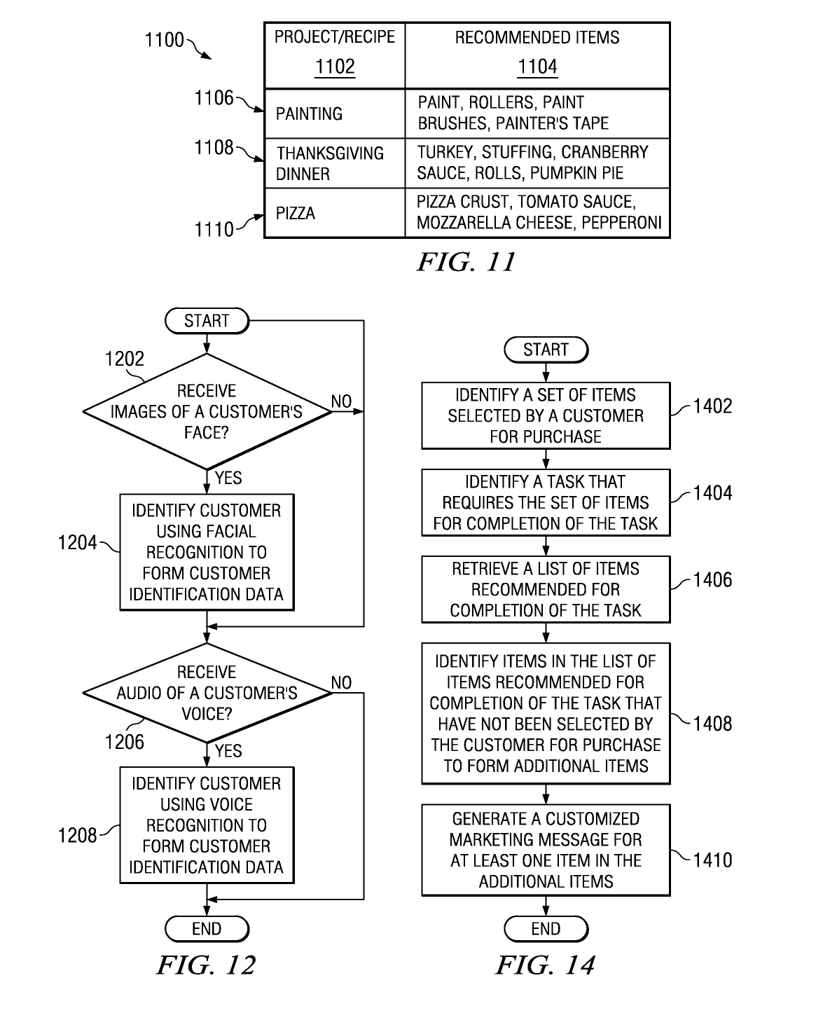

FIG. 11 is a block diagram illustrating a list of recommended items for completing projects or recipes in accordance with an illustrative embodiment. Project/recipe 1102 is a list of projects and/or recipes that a customer may be planning to perform or utilize. Recommended items 1104 is a list of the items that are needed to complete or finish a project or recipe in project/recipe 1102.

For example, if a data processing system associated with a retail facility analyzes camera data and/or identification tag data to determine that a customer has selected paint and placed the paint in the customer's shopping cart, the analysis server can identify painting 1106 as a potential project that the customer plans to undertake. Painting 1106 is a project associated with the additional recommended items of rollers, paint brushes, and painter's tape. Therefore, the analysis server generates a marketing message for the customer that includes at least one of rollers, paint brushes, and painter's tape. The marketing message may also include a location in the store and/or a location on an aisle or shelf for each items in the set of additional recommended items.

In another example, if a customer selects a turkey for purchase and current events data indicates Thanksgiving is within a predetermined number of days from the current date, the analysis server identifies Thanksgiving dinner 1108 as a recipe. The analysis server then identifies stuffing, cranberry sauce, rolls, and pumpkin pie as additional recommended items the customer may wish to purchase to complete the Thanksgiving dinner.

In another example, if pizza 1110 is identified as a recipe the customer commonly uses, the analysis server identifies pizza crust, tomato sauce, mozzarella cheese, and pepperoni as items that the customer frequently purchases or has purchased in the past. The analysis server then recommends the pizza recipe and provides a listing of the needed ingredients and/or a location of each ingredient in the retail facility, location on an aisle and/or location on a shelf or rack in the retail facility.

Thus, the analysis server can identify a recipe based on one or more items selected by the customer for purchase. In another embodiment, the analysis server identifies a recipe or project based solely on past purchases made by the customer and/or customer preferences available in a customer profile. In yet another example, the analysis server uses a combination of selected items for purchase, past transactions, and customer preferences to identify recipes and/or projects to recommend to the customer.

FIG. 12 is a flowchart illustrating a process for identifying a customer using dynamic data for the customer in accordance with an illustrative embodiment. The process is implemented by software for analyzing camera images to identify a customer, such as smart detection engine 1008 in FIG. 10.

The process begins by making a determination as to whether images of a customer's face are received (step 1202). If images are received, the process identifies the customer using facial recognition technology to form customer identification data (step 1204).

If images of a customer's face are not received at step 1202 or after using facial recognition technology, the process makes a determination as to whether audio of a customer's voice is received (step 1206). If audio is received, the process identifies the customer using voice recognition analysis to generate customer identification data (step 1208) with the process terminating thereafter. If audio is not available at step 1206, the process terminates thereafter.

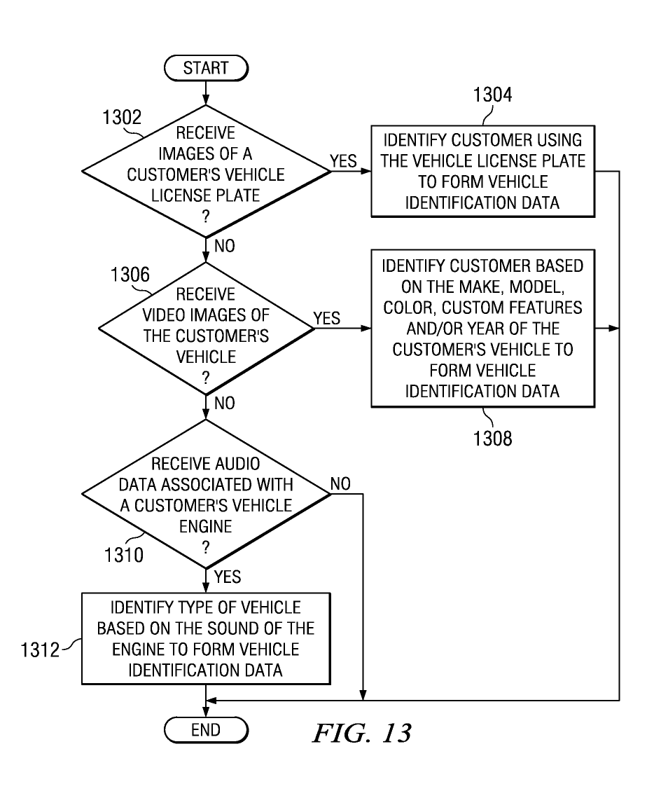

FIG. 13 is a flowchart illustrating a process for identifying a customer based on an identification of the customer's vehicle in accordance with an illustrative embodiment. The process is implemented by software for analyzing camera images to identify a customer, such as smart detection engine 1008 in FIG. 10.

The process begins by making a determination as to whether images of a customer's vehicle license plate are available (step 1302). If images are available, the process identifies the customer using the vehicle license plate to form vehicle identification data (step 1304). If images are not available at step 1302, the process makes a determination as to whether video images of the customer's vehicle are available (step 1306). If images are available, the process identifies the customer based on the make, model, color, year, and/or any other custom features of the customer's vehicle (step 1308) with the process terminating thereafter.

Returning to step 1306, if images of the customer's vehicle are not received, the process makes a determination as to whether audio data associated with the customer's vehicle engine is received (step 1310). If audio data is not received, the process terminates thereafter. If audio data is received, the process identifies the type of vehicle based on an analysis of the sound of the engine of the vehicle to form the vehicle identification data (step 1312) with the process terminating thereafter. Thus, a customer can be identified using audio or video data of the customer or the customer's vehicle.

FIG. 14 is a flowchart illustrating a process for identifying project based recommended items in accordance with an illustrative embodiment. The process is implemented by software for identifying items needed to complete a recipe or project, such as project recognition 421 in FIG. 4.

The process begins by identifying a set of items selected by a customer for purchase (step 1402). The set of items includes one or more items. The process identifies a task that requires the set of items for completion of the task (step 1404). The task is a recipe or project. The process retrieves a list of items recommended for completion of the task (step 1406).

The process identifies items in the list of recommended items for completion of the task that the customer has not selected for purchase to form additional items (step 1408). Finally, the process generates a customized marketing message for at least one item in the additional items (step 1410) with the process terminating thereafter. The customized marketing message may optionally include instructions for completing the task and a location in the retail facility where each of the additional items is located.

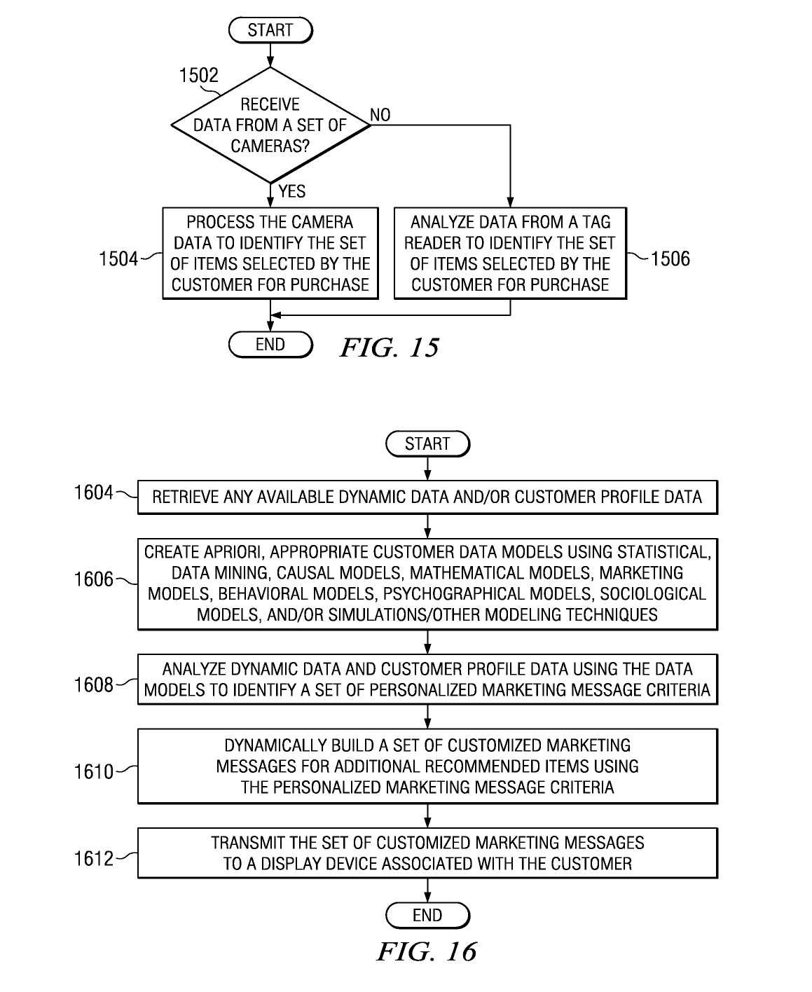

Referring now to FIG. 15, a flowchart illustrating a process for identifying items selected by a customer is shown in accordance with an illustrative embodiment. The process is implemented by software for analyzing identification tag data and camera images to identify selected items, such as smart detection engine 1008 in FIG. 10.

The smart detection engine begins by making a determination as to whether data is received from a set of cameras (step 1502). The set of cameras is one or more cameras. If data is received, the smart detection engine processes the camera data to identify the set of one or more items selected by the customer for purchase (step 1504) with the process terminating thereafter.

Returning to step 1502, if camera data is not received, the process analyzes data from a tag reader to identify the set of items selected by the customer for purchase (step 1506) with the process terminating thereafter.

FIG. 16 is a flowchart illustrating a process for generating a project based customized marketing message using dynamic data in accordance with an illustrative embodiment. The process in FIG. 16 is implemented by a server, such as analysis server 602 in FIG. 6.

The process begins by retrieving any available dynamic data and/or customer profile for a customer (step 1604). The dynamic data includes, without limitation, customer identification data, vehicle identification data, customer behavior data, and/or any other dynamic customer data elements.

The process pre-generates or creates in advance, appropriate data models using at least one of a statistical method, data mining method, causal model, mathematical model, marketing model, behavioral model, psychographical model, sociological model, simulations/modeling techniques, and/or any combination of models, data mining, statistical methods, simulations and/or modeling techniques (step 1606). The process analyzes dynamic data and customer profile data using one or more of the appropriate data models to identify a set of personalized marketing message criteria (step 1608). The set of personalized marketing message criteria may include one or more criterion for generating a personalized marketing message.

The process dynamically builds a set of one or more customized marketing messages for at least one additional recommended item using the personalized marketing message criteria (step 1610). The additional recommended item is an item that is suggested in addition to one or more items already selected by the customer for purchase. The process transmits the set of customized marketing messages to a display device associated with the customer (step 1612) for presentation of the marketing message to the customer, with the process terminating thereafter.

In this manner, the process identifies the customer, retrieves profile data for the customer, and information regarding current shopping basket contents, past purchases, customer preferences, customer's favorite recipes, customer hobbies, and previous market basket elements. The process also knows something about potential net new purchases. Once these elements are known, recipes or project elements are identified by matching the current shopping basket contents to known/current recipes and project. The recipes and projects are presented to the customer in addition to information regarding the location of these items in the retail facility to make their shopping experience easier and possibly increase market basket revenue.

The process may also be used to provide lists of needed ingredients for recipes and project that the customer is familiar with, in addition to presenting new recipes or project suggestions to the customer based on the customers preferences and past purchases.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the steps may occur out of the order noted in the figures. For example, two steps shown in succession may, in fact, be executed substantially concurrently, or the steps may sometimes be executed in the reverse order, depending upon the functionality involved.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

Further, a computer storage medium may contain or store a computer readable program code such that when the computer readable program code is executed on a computer, the execution of this computer readable program code causes the computer to transmit another computer readable program code over a communications link. This communications link may use a medium that is, for example without limitation, physical or wireless.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for generating project based marketing messages to a customer in a retail facility, the computer implemented method comprising:
identifying at least one item selected by the customer for purchase;
identifying a task that requires the at least one item for completion of the task;
retrieving a set of additional items recommended for completion of the task, wherein the customer has not selected the items in the set of additional items for purchase; and
generating a customized marketing message for at least one item in the set of additional items recommended for completion of the task, wherein the customized marketing message is generated in real-time as the customer is shopping.

2. The computer implemented method of claim 1 wherein the customized marketing message includes a location of the at least one item in the set of additional items recommended for completion of the task.

3. The computer implemented method of claim 1 wherein the customized marketing message includes a recipe or instructions for completing the task.

4. The computer implemented method of claim 1 wherein the customized marketing message includes a list of items recommended for completion of the task that the customer has already selected for purchase and a list of the items in the set of additional items recommended for completion of the task that the customer has not yet selected for purchase.

5. The computer implemented method of claim 1 wherein the customized marketing message includes an incentive to purchase the at least one item in the set of additional items recommended for completion of the task, wherein the incentive is at least one of a discount, a rebate, a coupon, a sale price, an offer of a free gift, a reward, or a special offer provided to the customer if the at least one item is purchased.

6. The computer implemented method of claim 1 further comprising:
receiving data from a set of cameras located inside the retail facility to form detection data;
processing the detection data, by a smart detection engine, to identify the at least one item selected by the customer.

7. The computer implemented method of claim 6 further comprising:
processing the detection data, by the smart detection engine, to identify the customer; and
personalizing the customized marketing message using data from a customer profile for the customer and the detection data, wherein the customized marketing message is a unique message that is generated specifically for the customer.

8. The computer implemented method of claim 1 further comprising:
receiving data from a set of radio frequency identification tags associated with the at least one item selected for purchase by the customer to form detection data; and
processing the detection data to identify the at least one item selected by the customer.

9. The computer implemented method of claim 1 further comprising:
identifying the customer;
retrieving a customer profile for the customer, wherein the customer profile includes previous items purchased by the customer in past transactions;
analyzing the items purchased by the customer in the past transactions to identify recipes associated with the previous items purchased; and
identifying the task that requires the at least one item using the recipes associated with the previous items purchased.

10. The computer implemented method of claim 9 wherein analyzing the items purchased by the customer in the past transactions to identify recipes associated with the previous items purchased further comprises:
comparing the previous items purchased to ingredients recommended for completion of recipes; and
identifying recipes associated with ingredients that match the previous items purchased.

11. The computer implemented method of claim 1 further comprising:
prompting the customer to identify the task, wherein a data processing system associated with the retail facility sends the prompt to a display device associated with the customer; and
responsive to the customer identifying the task, displaying the set of additional items recommended for completion of the task on the display device.

12. The computer implemented method of claim 1 further comprising:
responsive to the customer selecting a first item in the set of additional items, generating a next customized marketing message for a second item in the set of additional items, wherein the next customized marketing message comprises a location in the retail facility where the second item in the set of additional items is located.

13. The computer implemented method of claim 1 wherein identifying a task that requires the at least one item for completion of the task further comprises:
identifying the task using current events data, wherein the current events data indicates a seasonal event or holiday and wherein the task is at least one of a seasonal project, a seasonal recipe, a holiday recipe, or a holiday project.

14. A computer program product comprising:
a computer usable medium including computer usable program code for generating project based marketing messages to a customer in a retail facility, said computer program product comprising:
computer usable program code for identifying at least one item selected by the customer for purchase;
computer usable program code for identifying a task that requires the at least one item for completion of the task;
computer usable program code for retrieving a set of additional items recommended for completion of the task, wherein the customer has not selected the items in the set of additional items for purchase; and
computer usable program code for generating a customized marketing message for at least one item in the set of additional items recommended for completion of the task, wherein the customized marketing message is generated in real-time as the customer is shopping.

15. The computer program product of claim 14 wherein the customized marketing message includes at least one of a location of the at least one item in the set of additional items recommended for completion of the task, a recipe or instructions for completing the task, a list of items recommended for completion of the task that the customer has already selected for purchase, and a list of the items in the set of additional items recommended for completion of the task that the customer has not yet selected for purchase.

16. The computer program product of claim 14 further comprising:
computer usable program code for receiving data from a set of cameras located inside the retail facility to form detection data;
computer usable program code for processing the detection data, by a smart detection engine, to identify the at least one item selected by the customer.

17. The computer program product of claim 14 further comprising:
computer usable program code for identifying the customer;
computer usable program code for retrieving a customer profile for the customer, wherein the customer profile includes previous items purchased by the customer in past transactions;
computer usable program code for analyzing the items purchased by the customer in the past transactions to identify recipes associated with the previous items purchased; and
computer usable program code for identifying the task that requires the at least one item using the recipes associated with the previous items purchased.

18. The computer program product of claim 17 wherein analyzing the items purchased by the customer in the past transactions to identify recipes associated with the previous items purchased further comprises:
computer usable program code for comparing the previous items purchased to ingredients recommended for completion of recipes; and
computer usable program code for identifying recipes associated with ingredients that match the previous items purchased.

19. The computer program product of claim 14 further comprising:
computer usable program code for generating a next customized marketing message for a second item in the set of additional items in response to the customer selecting a first item in the set of additional items, wherein the next customized marketing message comprises a location in the retail facility where the second item in the set of additional items is located.

20. The computer program product of claim 14 wherein identifying a task that requires the at least one item for completion of the task further comprises:
computer usable program code for identifying the task using current events data, wherein the current events data indicates a seasonal event or holiday and wherein the task is at least one of a seasonal project, a seasonal recipe, a holiday recipe, or a holiday project.

21. A data processing system for generating project based customized marketing messages for a customer, the data processing system comprising:
a bus system;
a communications system connected to the bus system;
a memory connected to the bus system, wherein the memory includes computer usable program code; and
a processing unit connected to the bus system, wherein the processing unit executes the computer usable program code to identify at least one item selected by the customer for purchase; identify a task that requires the at least one item for completion of the task; retrieve a set of additional items recommended for completion of the task, wherein the customer has not selected the items in the set of additional items for purchase; and generate a customized marketing message for at least one item in the set of additional items recommended for completion of the task, wherein the customized marketing message is generated in real-time as the customer is shopping.

22. The data processing system of claim 21 wherein the processor unit further executes the computer usable program code to generate a next customized marketing message for a second item in the set of additional items in response to the customer selecting a first item in the set of additional items, wherein the next customized marketing message comprises a location in the retail facility where the second item in the set of additional items is located.

23. The data processing system of claim 21 wherein the processor unit further executes the computer usable program code to identify the task using current events data, wherein the current events data indicates a seasonal event or holiday and wherein the task is at least one of a seasonal project, a seasonal recipe, a holiday recipe, or a holiday project.

24. A system for generating project based marketing messages to a customer in a retail facility, the system comprising:
a set of cameras, wherein the set of cameras captures a set of images associated with the customer;
a smart detection engine, wherein the smart detection engine analyzes the camera images to identify at least one item selected by the customer for purchase;
a project recognition engine, wherein the project recognition engine identifies a task that requires the at least one item for completion of the task and retrieves a set of additional items recommended for completion of the task, wherein the customer has not selected the items in the set of additional items for purchase; and
a dynamic marketing message assembly, wherein the dynamic marketing message assembly generates a customized marketing message for at least one item in the set of additional items recommended for completion of the task, wherein the customized marketing message is generated in real-time as the customer is shopping.

25. The system of claim 24 further comprising:
an external marketing manager, wherein the external marketing manager receives data from a plurality of external news sources, and wherein the external marketing manager analyzes the data to form current events data, wherein the analysis server uses the current events data to identify the task and wherein the current events data indicates a seasonal event or holiday and wherein the task is at least one of a seasonal project, a seasonal recipe, a holiday recipe, and a holiday project.
